(19) United States
(12) Patent Application Publication
(10) Pub. No.: US 2023/0213211 A1
(43) Pub. Date: Jul. 6, 2023

(54) COOKING APPLIANCE

(71) Applicant: SAMSUNG ELECTRONICS CO., LTD., Suwon-si (KR)

(72) Inventors: Moonkyu KIM, Suwon-si (KR); Cheoleun CHOI, Suwon-si (KR)

(21) Appl. No.: 18/083,907

(22) Filed: Dec. 19, 2022

Related U.S. Application Data
(63) Continuation of application No. PCT/KR2022/020250, filed on Dec. 13, 2022.

(30) Foreign Application Priority Data
Jan. 6, 2022 (KR) 10-2022-0002284
Jan. 28, 2022 (KR) 10-2022-0013551

(51) Int. Cl. F24C 15/32; F24C 15/02

(52) U.S. Cl. CPC F24C 15/327; F24C 15/02

(57) ABSTRACT

A cooking appliance includes a main body defining a cooking chamber, a food-treatment material chamber open to outside the main body at an opening of the main body, and an outer surface having a stepped portion at the opening, a food-treatment container accommodated in the food-treatment material chamber and accessible from outside of the food-treatment material chamber, via the opening, a food-treatment material supplier supplying a food-treatment material from the food-treatment material chamber to the cooking chamber, a door coupled to main body and opening and closing the food-treatment material chamber, at the opening, and a door adjuster connected to the door, extended along the outer surface of the main body at the opening, and adjusting a planar position of the door at the opening to compensate the stepped portion of the outer surface of the main body.

### CROSS-REFERENCE TO RELATED APPLICATION

This application is a continuation application of International Application No. PCT/KR2022/020250 designating the United States, filed on Dec. 13, 2022, in the Korean Intellectual Property Receiving Office and claiming priority to Korean Patent Application No. 10-2022-0002284, filed on Jan. 6, 2022 and Korean Patent Application No. 10-2022-0013551, filed on Jan. 28, 2022, in the Korean Intellectual Property Office, the disclosures of which are incorporated by reference herein in their entireties.

### BACKGROUND

### 1. Field

Embodiments of the present disclosure relate to a cooking appliance. More particularly, embodiments of the present disclosure relate to a cooking appliance including a steam supply device which supplies steam to a cooking chamber.

### 2. Description of the Related Art

Cooking appliances are appliances for heating and cooking a target to be cooked, such as food, and refer to devices that provide various functions related to cooking such as heating, defrosting, drying, and sterilizing of the target to be cooked. Examples of such cooking appliances include an oven such as a gas oven or an electric oven, a microwave heating device (hereinafter referred to as a microwave), a gas stove, an electric stove, an over-the-range (OTR) microwave, a gas grill, an electric grill, and the like.

Generally, an oven is an appliance for cooking food by directly transferring heat to food via a heating source generating heat, such as a heater, or by heating the inside of a cooking chamber. A microwave is an appliance for cooking food by intermolecular frictional heat generated as the molecular arrangement of food is disturbed with high-frequency waves as the heating source.

An oven includes a cooking chamber for cooking food, and an electronic chamber for accommodating electronic components. In the process of cooking food, the inside of the cooking chamber is sealed to prevent high-temperature heat from escaping to the outside of the cooking chamber and/or the cooking appliance.

In order to improve the texture of food and reduce the loss of the nutrients in food, a cooking appliance including a steam supply device has been developed to provide steam to the inside of a cooking chamber during the cooking of food so that cooking can be performed indirectly by steam heat.

### SUMMARY

Embodiments he present provide a cooking appliance with an improved structure which improves the external appearance of the cooking appliance.

Embodiments of the present disclosure provide a cooking appliance with an improved structure which adjusts an exterior step difference between a steam door and a main body.

Additional features of the disclosure will be set forth in part in the description which follows and, in part, will be obvious from the description, or may be learned by practice of the disclosure.

In accordance with an embodiment of the present disclosure, a cooking appliance includes a main body having a cooking chamber and an accommodation chamber provided therein and including a frame fastening portion, a steam supply device configured to supply steam to the cooking chamber and including a steam container disposed in the accommodation chamber to store water for steam generation, a steam door coupled to the main body to open or close the accommodation chamber, a door pusher provided to come in contact with the steam door upon closing of the steam door, a support frame configured to support the door pusher, and an adjustment member configured to fasten the support frame to the frame fastening portion and provided to adjust a position of the support frame relative to the frame fastening portion.

The cooking appliance may further include an elastic member disposed between the main body and the support frame so that the support frame is elastically supported relative to the main body.

The elastic member may be disposed between the frame fastening portion and one surface of the support frame that is adjacent to the frame fastening portion.

The elastic member may have an end coupled to the frame fastening portion and may be formed to be elastically deformable in a direction parallel to a direction in which the frame fastening portion and the support frame are fastened.

The support frame may receive an elastic force from the elastic member in the direction parallel to the direction in which the frame fastening portion and the support frame are fastened.

The support frame may include a first side facing the frame fastening portion, a second side opposite to the first side, and a through-hole formed to allow the adjustment member to pass through the first side and the second side.

The adjustment member may include a fastening head bound to the second side so that the adjustment member is not able to move to the first side, and a fastening body provided to extend from the fastening head, pass through the through-hole, and be inserted into the frame fastening portion, and the through-hole may be formed to be smaller than a diameter of the fastening head and larger than a diameter of the fastening body.

The steam door may be rotatably coupled to the main body, and the through-hole may be formed to extend in a direction parallel to a direction of an axis of rotation of the steam door.

The adjustment member may further include an elastic member extending to surround the fastening body and including a coil disposed between the first side of the support frame and the frame fastening portion.

The adjustment member may be provided in plural including a plurality of adjustment members, the frame fastening portion may be provided in plural including a plurality of frame fastening portions to correspond to the plurality of adjustment members, and each of the plurality of adjustment members may be provided to independently adjust a distance from each of the plurality of frame fastening portions to the support frame.

The steam door may be rotatably coupled to the main body, and the plurality of adjustment members may be disposed in the direction of the axis of rotation of the steam door.

The door pusher may be disposed between the plurality of adjustment members.

The main body may include an outer frame including a first frame portion provided to be covered by the steam door and a second frame portion disposed adjacent to the first frame portion, and the outer frame may be formed to be stepped so that the second frame portion protrudes more outward than the first frame portion.

The adjustment member may be provided to change the position of the support frame relative to the first frame portion to adjust a step difference between the steam door and the second frame portion.

The door pusher may be provided to be movable relative to the support frame and may be provided to, upon moving from the support frame toward the steam door, press the steam door so that the steam door is opened.

In accordance with an embodiment of the present disclosure, a cooking appliance includes a main body having a cooking chamber and an accommodation chamber provided therein and including a frame fastening portion, a steam supply device configured to supply steam to the cooking chamber and having at least a portion disposed in the accommodation chamber, a steam door coupled to the main body to open or close the accommodation chamber, a support frame disposed in the accommodation chamber and provided so that a position relative to the frame fastening portion varies, a door pusher provided to, upon closing of the steam door, come in contact with an inner surface of the steam door that faces the main body and provided to protrude from the support frame to pass through the main body and vary the position of the steam door according to a change in the position of the support frame, and an adjustment member configured to fasten the support frame to the frame fastening portion to adjust a position of the support frame relative to the frame fastening portion by varying a fastening distance between the support frame and the frame fastening portion.

The cooking appliance may further include an elastic member disposed between the main body and the support frame so that the support frame is elastically supported relative to the main body.

The elastic member may have one end coupled to the frame fastening portion and may be provided to extend in a direction in which the support frame is fastened to the frame fastening portion and be elastically deformable.

The adjustment member may be provided as a plurality of adjustment members, the frame fastening portion may be provided as a plurality of frame fastening portions to correspond to the plurality of adjustment members, and each of the plurality of adjustment members may be provided to independently adjust a distance from each of the plurality of frame fastening portions to the support frame.

In accordance with an embodiment of the present disclosure, a cooking appliance includes a main body in which a cooking chamber and an accommodation chamber, each having an opening formed therein, are formed and which includes a frame fastening portion, a container disposed in the accommodation chamber and able to be taken out through the opening of the accommodation chamber, a door coupled to the main body to open or close the opening of the accommodation chamber, a door pusher of which at least a portion protrudes from the accommodation chamber and which is provided to come in contact with the door upon closing of the door, a support frame disposed in the accommodation chamber and configured to support the door pusher, an adjustment member configured to fasten the support frame to the frame fastening portion to adjust a position of the door pusher relative to the frame fastening portion, and an elastic member disposed between the main body and the support frame so that the support frame is elastically supported relative to the main body.

### BRIEF DESCRIPTION OF THE DRAWINGS

These and/or other features of the disclosure will become apparent and more readily appreciated from the following description of the embodiments, taken in conjunction with the accompanying drawings of which:

FIG. 1 is a perspective view illustrating a cooking appliance according to one embodiment of the present disclosure;

FIG. 2 is an exploded front perspective view of the cooking appliance of FIG. 1;

FIG. 3 is an exploded rear perspective view illustrating the cooking appliance of FIG. 1;

FIG. 4 is an enlarged view of portion A of FIG. 2;

FIG. 5 is an enlarged view of portion B of FIG. 3;

FIG. 6 is an exploded perspective view illustrating a hinge shaft member of the cooking appliance according to one embodiment of the present disclosure;

FIG. 7 is a view illustrating an outer frame and a steam door of the cooking appliance according to one embodiment of the present disclosure;

FIG. 8 is an exploded view illustrating the coupling relationship of a frame fastening portion, a support frame, a door pusher, and an adjustment member of the cooking appliance according to one embodiment of the present disclosure;

FIG. 9 is a cross-sectional view illustrating a door pusher assembly of the cooking appliance according to one embodiment of the present disclosure;

FIG. 10 is a cross-sectional view illustrating a door pusher assembly of the cooking appliance according to one embodiment of the present disclosure;

FIG. 11 is a cross-sectional view illustrating a door pusher assembly of the cooking appliance according to one embodiment of the present disclosure;

FIG. 12 is an exploded perspective view illustrating a door pusher assembly according to another embodiment of the present disclosure;

FIG. 13 is a perspective view illustrating the support frame of the cooking appliance according to one embodiment of the present disclosure;

FIG. 14 is a front view of the support frame of FIG. 13;

FIG. 15 is a top view illustrating the support frame fastened to the frame fastening portion in the cooking appliance according to one embodiment of the present disclosure;

FIG. 16 is a top view illustrating the position of the steam door adjusted using the adjustment member in the cooking appliance of FIG. 15; and

FIG. 17 is a top view illustrating the position of the steam door adjusted using the adjustment member in the cooking appliance of FIG. 15.

### DETAILED DESCRIPTION

Embodiments described herein and configurations illustrated in the drawings are merely embodiments of the present disclosure, and various modifications which may replace the embodiments and the drawings herein may be present at the time of filing this application.

Like reference numerals or symbols presented in the drawings of the application indicate components or elements that perform substantially the same functions. As used herein, a reference number may indicate a singular element or a plurality of the element. For example, a reference number labeling a singular form of an element within the drawing figures may be used to reference a plurality of the singular element within the text of specification.

It will be understood that when an element is referred to as being related to another element such as being “on” another element, it can be directly on the other element or intervening elements may be present therebetween. In contrast, when an element is referred to as being related to another element such as being “directly on” another element, there are no intervening elements present.

Terms used herein are for describing the embodiments and are not intended to limit and/or restrict the disclosure. A singular expression includes a plural expression unless context clearly indicates otherwise. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items.

In the application, terms such as “include” or “have” are for designating that features, numbers, steps, operations, elements, components, or combinations thereof are present, and do not preclude the possibility of presence or addition of one or more other features, numbers, steps, operations, elements, components, or combinations thereof in advance.

Terms including ordinals such as “first” and “second” used herein may be used to describe various elements, but the elements are not limited by the terms, and the terms are only used for the purpose of distinguishing one element from another element. For example, a first element may be referred to as a second element while not departing from the scope of the present disclosure, and likewise, a second element may also be referred to as a first element. The term “and/or” includes a combination of a plurality of related described items or any one item among the plurality of related described items.

Terms such as “up-down direction,” “below,” and “front-rear direction” used in the following description are defined based on the drawings, and the shape and position of each element are not limited by the terms.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

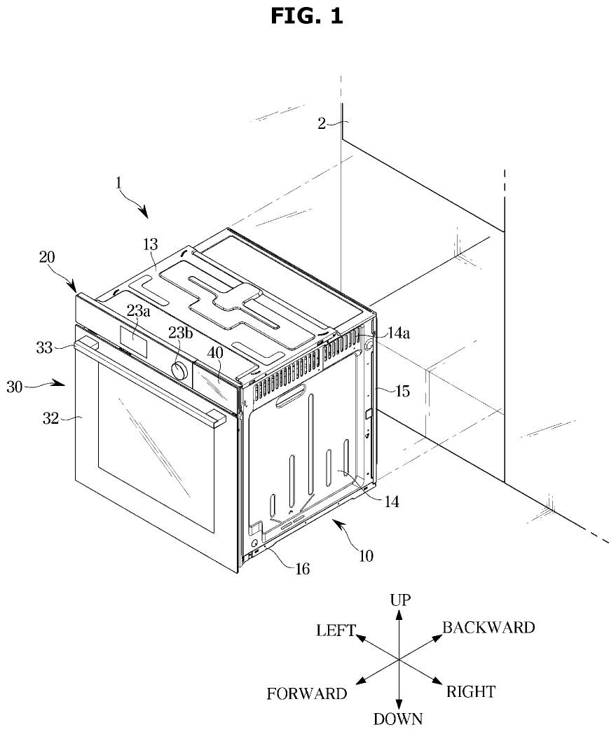

For example, “front surface,” “forward” and “front” used below refer to a direction toward a front surface and the front that are seen from the front of a cooking appliance 1 illustrated in FIG. 1, and “back surface,” “backward” and “back” refer to a direction toward a back surface and the back that are seen from the back of the cooking appliance 1. The forward and backward directions may be opposite to each other, and may generally define a first direction. The left and right directions may be opposite to each other and may generally define a second direction. The up and down directions may be opposite to teach other and may define a third direction or a thickness direction. The first, second and third directions may cross each other. A plane may be defined by two directions crossing each other, without being limited thereto.

Hereinafter, embodiments according to the present disclosure will be described in detail with reference to the accompanying drawings.

Further, although the cooking appliance 1 according to one embodiment of the present disclosure is described below as a built-in type cooking appliance that is installed inside a kitchen cabinet, the spirit of the present disclosure is not limited thereto. Also, although, for convenience of description, the cooking appliance 1 according to one embodiment of the present disclosure is described below assuming that it is an oven, the spirit of the present disclosure is not limited thereto, and the cooking appliance 1 according to one embodiment of the present disclosure may also be various other types of cooking appliances such as a microwave.

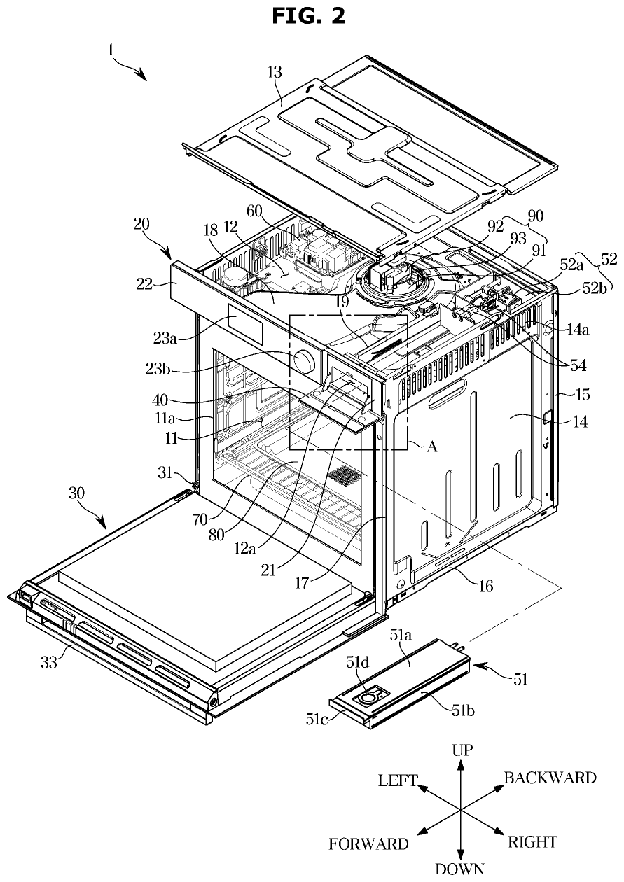

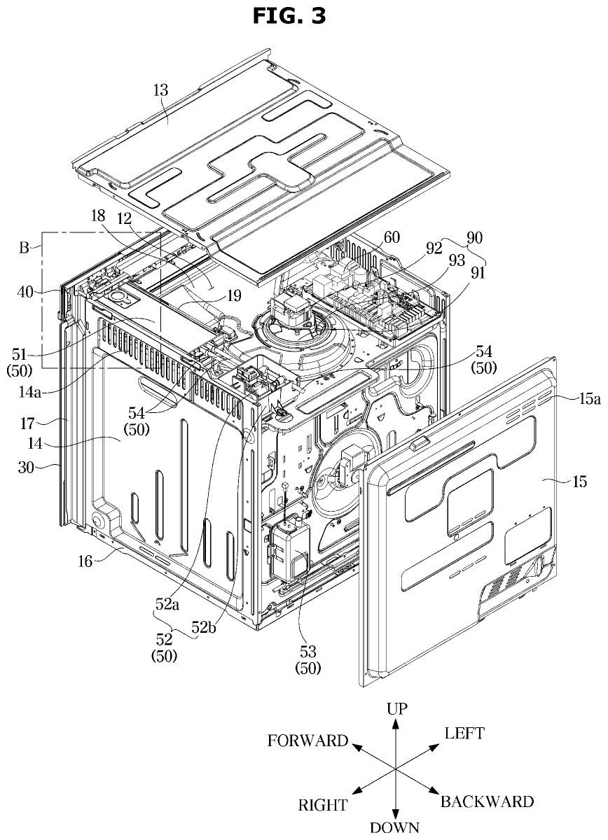

FIG. 1 is a perspective view illustrating the cooking appliance 1 according to one embodiment of the present disclosure. FIG. 2 is a view illustrating a state in which a top panel 13 and a steam container are separated from the cooking appliance 1 of FIG. 1. FIG. 3 is a rear perspective view illustrating a state in which the top panel 13 and a back panel are separated from the cooking appliance 1 of FIG. 1.

Referring to FIGS. 1 to 3, the cooking appliance 1 may be installed inside a wall or a cabinet 2 to have a sense of unity with a kitchen space. That is, the cooking appliance 1 may be referred to as a built-in type of appliance.

The cabinet 2 for installation of the cooking appliance 1 may have an opening formed (or provided) in at least a portion of a front surface of the cabinet 2, to be open toward the front side, and the cooking appliance 1 may be accommodated in the cabinet 2 through the opening. The cooking appliance 1 may be installed inside the cabinet 2 or taken out from inside the cabinet 2 through the opening of the cabinet 2. For example, the cooking appliance 1 may be taken out from inside the cabinet 2 for repair, component replacement, or the like or for, as will be described below, adjusting the position of a support frame 100 relative to a frame fastening portion 200 using an adjustment member 400 after separating a top panel 13.

However, the present disclosure is not limited thereto, and the built-in type cooking appliance 1 may also be accommodated in a modified cabinet (not illustrated) with an open upper portion, unlike the cabinet 2 illustrated in FIG. 1. In this case, since the top panel 13 of the cooking appliance 1 may be exposed upward, a user may separate the top panel 13 and perform a desired task without taking the cooking appliance 1 out of the modified cabinet with an open upper portion. Of course, as described above, the cooking appliance 1 may not be a built-in type, and even in this case, the top panel 13 of the cooking appliance 1 may be exposed upward.

The cooking appliance 1 may include a main body 10 forming an exterior of the cooking appliance 1. A cooking chamber 11 in which food to be cooked is placed and cooking of the food to be cooked is performed may be provided inside the main body 10. An opening 11a of the cooking chamber 11 that is opened (e.g., in an open position) to allow food to be cooked to be placed in and taken out of the cooking chamber 11, may be formed in or provided by the main body 10. Generally, one surface of the cooking appliance 1 in which the opening 11a of the cooking chamber 11 is formed may be defined as the front surface of the cooking appliance 1. The opening 11a may expose the cooking chamber 11 to outside the cooking appliance 1.

The main body 10 may include the top panel 13, a side panel 14, a back panel 15, and a base 16 which form the exterior of the cooking appliance 1. Each of the top panel 13, the side panel 14, the back panel 15, and the base 16 may be formed to include a flat plate shape, but the present disclosure is not limited thereto.

The top panel 13 may be disposed on an upper portion of the main body 10 and form a top surface of the cooking appliance 1. The side panel 14 may be provided as a plurality of side panels 14. The plurality of side panels 14 may be respectively disposed on a left side and a right side of the main body 10 and form a left surface and a right surface of the cooking appliance 1. The back panel 15 may be disposed on the back of the main body 10 and form a back surface of the cooking appliance 1. The base 16 may be disposed on a lower portion of the main body 10 and form a bottom surface of the cooking appliance 1. The front surface of the cooking appliance 1 may be formed or defined by a cooking chamber door 30 together with various elements, such an outer frame 20 and a steam door 40. The cooking appliance is openable and closeable by opening and closing of the cooking chamber door 30.

The top panel 13, the side panels 14, the back panel 15, and the base 16 may be detachably coupled to each other. However, the present disclosure is not limited thereto, and only some of the top panel 13, the side panels 14, the back panel 15, and the base 16 may be detachable, and the rest may be integrally formed with each other such as to be fixedly coupled thereto. For example, in the main body 10, only the top panel 13 may be provided to be detachable, and the side panels 14, the back panel 15, and the base 16 may be integrally formed with each other.

Heat dissipation holes 14a and 15a formed to dissipate heat from inside an accommodation chamber 12 may be provided in the side panels 14 and the back panel 15, respectively. However, the present disclosure is not limited thereto, and the heat dissipation holes 14a and 15a may be formed in only some of the side panels 14 and the back panel 15.

The main body 10 may include an opening frame 17 disposed at the front of the main body 10. The opening frame 17 may cover at least a portion of the front surface of the main body 10 and be formed in the shape of a frame with an opening. That is, the opening frame 17 may be formed along the perimeter of the opening 11 a of the cooking chamber 11.

The front surface of the opening frame 17 may be covered by the cooking chamber door 30 upon closing of the cooking chamber door 30. That is, the cooking chamber door 30 (or the cooking appliance 1) which is closed, disposes the front surface of the opening frame 17 covered by the cooking chamber door 30.

The opening frame 17 may be disposed between the side panels 14 and the cooking chamber door 30 or between the side panels 14 and the outer frame 20.

A plate 80 configured to accommodate food and a rack 70 configured to support the plate 80, may be provided inside the cooking chamber 11. The plate 80 may have various shapes that can accommodate targets for heating or cooking, such as food.

The rack 70 may be provided to be insertable into and withdrawable from the cooking chamber 11 through the opening 11a of the cooking chamber 11. Specifically, the rack 70 may be inserted into the cooking chamber 11 or withdrawn from the cooking chamber 11 by sliding with respect to the cooking chamber 11.

In addition, a heater (not illustrated) provided to supply heat for cooking food to be cooked, a steam inlet (not illustrated) provided to allow entry of steam supplied from a steam supply device 50 which will be described below, and a cooking chamber fan (not illustrated) provided to allow a smooth flow of heat, steam, or the like in the cooking chamber 11 may be provided inside the cooking chamber 11. However, the present disclosure is not limited thereto, and various other configurations may be provided inside the cooking chamber 11 according to the purpose, functions, and the like of the cooking appliance 1. That is, the heater, the steam inlet and the fan may be in communication with the cooking chamber 11.

The inside of the cooking chamber 11 may be coated with a material to prevent corrosion of an inner wall of the cooking chamber 11 due to condensate, which may be formed in a process of condensation of steam or the like, or moisture contained in the food to be cooked. The inside of the cooking chamber 11 may be dried by heat generated in a process of cooking food to be cooked.

The cooking appliance 1 may include the cooking chamber door 30 which is openable and closeable, and provided to open or close the cooking chamber 11 relative to an outside of the cooking appliance 1. The cooking chamber door 30 may be rotatably coupled to the main body 10 to open or close the opening 11a of the cooking chamber 11.

The cooking chamber door 30 may include a cooking chamber door hinge 31 and may be rotatably connected to the main body 10. The cooking chamber door hinge 31 may be coupled to lower ends of both sides of the main body 10, and an axis of rotation of the cooking chamber door 30 may be formed to be parallel to the lower ends of the main body 10, such as along a second direction (e.g., along the left-and-right directions). However, the present disclosure is not limited thereto, and a way in which the cooking chamber door 30 rotates relative to the main body 10 may vary. For example, the cooking chamber door hinge 31 may be vertically coupled to one side of the main body 10 (e.g., along a third direction such as along the up-and-down directions), and in this case, an axis of rotation of the cooking chamber door 30 may be formed to be parallel to the up-down direction of the main body 10.

The cooking chamber door 30 may include a transparent portion 32 formed to be transparent to allow the inside of the cooking chamber 11 to be viewable from outside the cooking appliance 1, such as by a user, even in a state in which the cooking chamber door 30 is closed. The transparent portion 32 may include a transparent material, e.g., a heat-resistant glass material, but the present disclosure is not limited thereto.

The cooking chamber door 30 may include a handle 33 provided to actuate the cooking chamber door 30, such as to be held by a user's hand, and allow the user to manually open or close the cooking chamber door 30. The handle 33 may be provided to be adjacent to a side of the cooking chamber door 30 that is opposite to the cooking chamber door hinge 31 and may be provided to allow the user to easily open or close the cooking chamber door 30. However, the present disclosure is not limited thereto, and the cooking chamber door 30 may be provided to be automatically opened or closed (e.g., non-manually), such as by electronic control.

The cooking appliance 1 may include the accommodation chamber 12 provided separated from the cooking chamber 11. The accommodation chamber 12 may be provided inside the main body 10 and may be partitioned from the cooking chamber 11 of the main body 10 by a partition 18.

Electronic components such as a main printed circuit board (PCB) 60 for controlling or performing functions of the cooking appliance 1 may be disposed inside the accommodation chamber 12. That is, the accommodation chamber 12 may include an electronic chamber. The electronic components may be supported ono the partition 18, without being limited thereto.

The electronic components including the main PCB 60 may receive power from an external power source, such as through a wire (not illustrated), or may be connected to each other. The electronic components may, while receiving power through the wire, transmit and receive electrical signals to and from each other to operate the cooking appliance 1 and perform functions of the cooking appliance 1. For example, the steam supply device 50 may be provided to be connected to the main PCB 60 or the like through the wire and perform a function. That is, the main PCB 60 may also control operation of the steam supply device 50 within the cooking appliance 1.

However, the present disclosure is not limited thereto, and the accommodation chamber 12 may be separately provided from the electronic chamber of the accommodation chamber 12.

The accommodation chamber 12 may be provided at an upper portion of the main body 10. That is, the accommodation chamber 12 may be disposed above the cooking chamber 11. In this case, the top panel 13 may be disposed on an upper portion of the accommodation chamber 12 and form a top surface of the accommodation chamber 12, and the partition 18 may be disposed on a lower portion of the accommodation chamber 12 and form a bottom surface of the accommodation chamber 12.

Since the accommodation chamber 12 is provided at the upper portion of the main body 10, the user can separate the top panel 13 from the side panels 14 and the back panel 15 to easily access the accommodation chamber 12 and perform a desired task. For example, the user may separate the top panel 13 to repair or replace the electronic components inside the accommodation chamber 12 or to, as will be described below, adjust the position of the support frame 100 using the adjustment member 400.

A cooling fan module 90 configured to cool heat generated from the electronic components such as the main PCB 60 may be provided inside the accommodation chamber 12. As will be described below, components of the steam supply device 50, such as a steam pump module 52, may be disposed inside the accommodation chamber 12 and generate heat, and the heat generated therefrom may also be reduced, dissipated and/or cooled using the cooling fan module 90.

The cooling fan module 90 may include a fan motor 92 and a cooling fan 91 provided to receive power from the fan motor 92 and rotate. As the cooling fan 91 rotates, a temperature inside the accommodation chamber 12 may decrease. The fan motor 92 may be supported by a motor bracket 93, and the motor bracket 93 may be fixed to the partition 18.

The cooking appliance 1 may include the steam supply device 50 provided to supply steam to the cooking chamber 11. The steam supply device 50 may include a steam container 51 disposed in the accommodation chamber 12 to store water for steam generation, a steam generator 53 configured to receive the water stored in the steam container 51 and generate steam, and the steam pump module 52 configured to supply the water of the steam container 51 to the steam generator 53.

The steam container 51 may have a water storage space (not illustrated) formed therein to store the water for steam generation.

An injection port (not illustrated) may be provided in the steam container 51 to allow water to be injected into the steam container 51 from outside the steam container 51. The steam container 51 may include a cap 51d provided to open or close the injection port, and the user may open the cap 51d and inject water into the steam container 51.

The injection port of the steam container 51 and the cap 51d opening or closing the injection port may be provided at an upper portion of the steam container 51. However, the present disclosure is not limited thereto, and the injection port and the cap 51d of the steam container 51 may be disposed at various other sites of the steam container 51. For example, the injection port of the steam container 51 and the cap 51d opening or closing the injection port may be provided at a front surface of the steam container 51.

The steam container 51 may include a steam container body 51b and a steam container cover 51a coupled to an upper portion of the steam container body 51b. The steam container body 51b may be formed to have an open upper portion, and water may be stored in the steam container body 51b. The steam container cover 51a may be coupled to the upper portion of the steam container body 51b and cover the open upper portion of the steam container body 51b. The above-described injection port and cap 51d of the steam container 51 may be provided at the steam container cover 51a.

The steam container cover 51a may be provided to be detachable from the steam container body 51b. Accordingly, the user can separate the steam container cover 51a from the steam container body 51b and easily wash or dry the inside of the steam container 51. However, the present disclosure is not limited thereto, and the steam container 51 may be formed as one body without the steam container cover 51a and the steam container body 51b being distinguished from each other.

The steam container 51 may have at least a portion formed to be transparent to allow the user to check a residual amount of water stored in the steam container 51. For example, at least a portion of the steam container 51 may be configured to include a transparent plastic material.

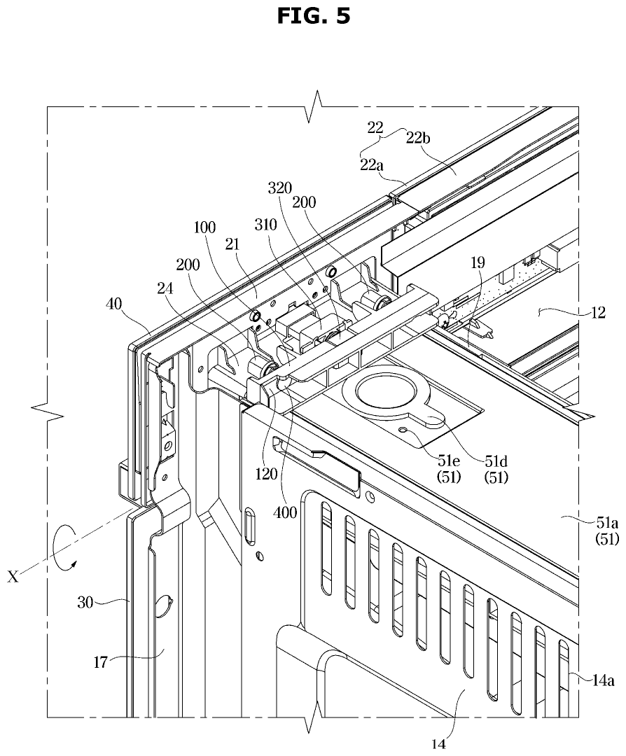

The steam container 51 may include a ventilation hole 51e (see FIG. 5) formed therein to allow the inside and outside of the steam container 51 to communicate with each other and to allow air to enter and exit the steam container 51. In a case in which the water of the steam container 51 moves to the steam generator 53 due to the steam pump module 52, the steam container 51 being sealed may cause pressure inside the steam container 51 to decrease and efficiency of the steam pump module 52 to decrease. Therefore, the steam container 51 may include the ventilation hole 51e configured to communicate with outside air to maintain a constant pressure inside the steam container 51. The ventilation hole 51e may be formed in an upper portion of the steam container 51, that is, the steam container cover 51a, but the present disclosure is not limited thereto.

An opening 12a may be formed in the accommodation chamber 12, and the steam container 51 may be withdrawn from the accommodation chamber 12 or inserted into the accommodation chamber 12 through the opening 12a of the accommodation chamber 12. The opening 12a of the accommodation chamber 12 may be opened or closed by the steam door 40 which will be described below.

That is, the steam container 51 may be detachably mounted in the accommodation chamber 12. As illustrated in FIG. 2, the opening 12a of the accommodation chamber 12 may be formed in the front of the accommodation chamber 12, and the steam container 51 may be withdrawn forward or inserted backward through the opening 12a of the accommodation chamber 12. However, the present disclosure is not limited thereto, and a direction in which the steam container 51 is inserted or withdrawn is not limited thereto. Further, the opening 12a of the accommodation chamber 12 may be formed to correspond to a direction in which the steam container 51 is inserted or withdrawn, and the steam door 40, which will be described below, may also be provided at a position at which the opening 12a of the accommodation chamber 12 can be opened or closed thereby.

The steam container 51 may include a grip portion 51c formed for the user to hold when withdrawing the steam container 51 through the opening 12a of the accommodation chamber 12. The grip portion 51c may be formed on one end of the steam container 51 and may be formed in a direction in which the steam container 51 is withdrawn. Specifically, in a case in which the steam container 51 is withdrawn forward from the accommodation chamber 12 as illustrated in FIG. 2, the grip portion 51c may be provided at the front of the steam container 51.

By such a configuration, the user can easily withdraw the steam container 51 from the accommodation chamber 12, inject water into the steam container 51, and then insert the steam container 51 back into the accommodation chamber 12.

However, the present disclosure is not limited thereto, and the steam container 51 is not necessarily inserted into or withdrawn from the accommodation chamber 12. For example, the steam container 51 may be provided to be filled with water by the user opening the steam door 40 and injecting water through the injection port (not illustrated) of the steam container 51 in a state in which the steam container 51 remains disposed inside the accommodation chamber 12. In this case, the injection port (not illustrated) for injecting water into the steam container 51 may be provided in a front surface of the steam door 40.

Hereinafter, for convenience of description, description will be given assuming that the steam container 51 is provided to be withdrawn from the accommodation chamber 12 or inserted into the accommodation chamber 12 through the opening 12a of the accommodation chamber 12.

The accommodation chamber 12 may include a fixing case 19 provided to accommodate the steam container 51. The fixing case 19 may be fixed to an inner side of the accommodation chamber 12, and the steam container 51 may be provided to be inserted into or withdrawn from the fixing case 19. In other words, the fixing case 19 may be disposed to be fixed to the accommodation chamber 12, and the steam container 51 may be mounted to be detachable from (e.g., detachably mounted relative to) the fixing case 19. The fixing case 19 may be disposed to be adjacent to the opening 12a of the accommodation chamber 12 inside the accommodation chamber 12. An inside of the fixing case 19 may communicate with the opening 12a.

The fixing case 19 may be provided to cover at least a portion of the steam container 51 from the outside. However, the fixing case 19 may be provided to not cover (e.g., exposed) one surface of the steam container 51 that is adjacent to (e.g., closest to) the opening 12a of the accommodation chamber 12 in order to allow the steam container 51 to be inserted or withdrawn through the opening 12a of the accommodation chamber 12.

The fixing case 19 may have an open upper portion. That is, the fixing case 19 may have an open upper portion so that the steam container cover 51a, which is the upper portion of the steam container 51, is exposed upward.

In other words, the fixing case 19 may have the shape of a box whose front surface and top surface are open to outside the fixing case 19. However, the present disclosure is not limited thereto, and the fixing case 19 may be provided to also cover a top surface of the steam container 51.

The fixing case 19 may be provided to communicate with the steam pump module 52, by a water supply pipe 54. Also, the fixing case 19 may be provided to communicate with the inside of the steam container 51 when the steam container 51 is mounted in the accommodation chamber 12. In this case, when the steam container 51 is inserted into the accommodation chamber 12, the steam container 51 may communicate with the steam pump module 52, through the fixing case 19.

As the steam container 51 is accommodated by the fixing case 19, the steam container 51 can be guided to be more easily inserted into or withdrawn from the accommodation chamber 12 as compared to when the fixing case 19 is not provided, and the steam container 51 can be stably supported even after being inserted into the accommodation chamber 12. However, the present disclosure is not limited thereto, and the fixing case 19 is not necessarily provided in the accommodation chamber 12.

The steam pump module 52 may generate pressure to perform a function of supplying the water of the steam container 51 to the steam generator 53. The steam pump module 52 may be provided to communicate with each of the steam container 51 and the steam generator 53 and supply the water stored in the steam container 51 to the steam generator 53.

The steam pump module 52 may include a steam pump 52a configured to generate pressure which moves the water, and a pump housing 52b configured to accommodate the steam pump 52a. The pump housing 52b may be fixed to the partition 18. However, the present disclosure is not limited thereto, and the steam pump module 52 may not include a separate pump housing 52b.

The steam pump 52a may be provided in plural as including a plurality of steam pumps 52a. Specifically, at least some of the plurality of steam pumps 52a may perform a function of supplying the water stored in the steam container 51 to the steam generator 53, and a remainder of the plurality of steam pumps 52a may perform a function of recovering water, which is left after generating steam in the steam generator 53, to the steam container 51. However, the present disclosure is not limited thereto, and the steam pump 52a may be provided as a single steam pump 52a.

The steam generator 53 may be provided to heat the water received from the steam container 51 through the steam pump module 52, and generate steam. The steam generator 53 may include a separate heater (not illustrated) to heat the received water or may receive heat from a heater (not illustrated) configured to supply heat to the cooking chamber 11.

The water supply pipe 54 provided to connect each of the components of the steam supply device 50 to each other, to allow water to pass therethrough, may be provided in the steam supply device 50. For example, the water supply pipe 54 may connect each of the components of the steam supply device 50 to each other, to supply water from the steam container 51 to the steam generator 53 via the steam pump 52a and/or to recover water left after steam generation to the steam container 51.

The steam supply device 50 may be provided to be connected to the electronic components such as the main PCB 60 through the wire (not illustrated) and receive power or transmit and receive electrical signals to and from the electronic components. In particular, the steam pump 52a and the steam generator 53 may be connected to the wire to receive power or may transmit and receive electrical signals to move water and generate or supply steam.

However, the configuration of the steam supply device 50 is not limited to the above, and the steam supply device 50 may include various other configurations to generate steam from the water stored in the steam container 51 and supply steam to the cooking chamber 11.

At least a portion of the steam supply device 50 including the steam container 51 may be disposed inside the accommodation chamber 12. As illustrated in FIGS. 2 to 3, the steam container 51 and the steam pump module 52 may be disposed inside the accommodation chamber 12, and the steam generator 53 may be provided at the back of the main body 10. However, the present disclosure is not limited thereto, and the configurations of the steam supply device 50 may be disposed in various other ways.

In a case in which the accommodation chamber 12 is separately provided from the electronic chamber, the accommodation chamber 12 may refer to a space in which only the steam supply device 50 is disposed or a space in which the steam container 51 of the steam supply device 50 is disposed.

The cooking appliance 1 may include a manipulation device 23b provided for the user to manipulate a function of the cooking appliance 1, and a display device 23a provided to display information such as a state or status of the cooking appliance 1, to outside the cooking appliance 1 like the user. The display device 23a and the manipulation device 23b may be provided on the front surface of the cooking appliance 1 for convenience of the user, but the present disclosure is not limited thereto.

The display device 23a and the manipulation device 23b may be electrically connected to a control PCB (not illustrated). Upon manipulation of the manipulation device 23b and input of a command, an electrical signal may be transmitted to the control PCB and a function or an operation of the cooking appliance 1 may be controlled. The display device 23a may display various pieces of information related to the cooking appliance 1, such as the temperature inside the cooking chamber 11, a food cooking mode, and the like.

The user may set a heating temperature or the like inside the cooking chamber 11 and/or set a food cooking method such as a cooking mode by using the manipulation device 23b. For example, the user may execute a mode for steam-cooking food by using the manipulation device 23b, and accordingly, the above-described steam supply device 50 may perform a steaming function. Although the manipulation device 23b is illustrated as a dial-type physical manipulation device in FIGS. 1 and 2, the type of manipulation device 23b is not limited thereto.

The display device 23a may include a touch display panel, and in this case, the display device 23a may be provided to separately receive an external input from outside the cooking appliance 1, such as a contact, a pressure, a light, a proximity (e.g., like hovering) from an input tool such as a body part, a stylus pen, etc.

The display device 23a and the manipulation device 23b may be provided on the outer frame 20, but the present disclosure is not limited thereto. A specific configuration of the outer frame 20 will be described below.

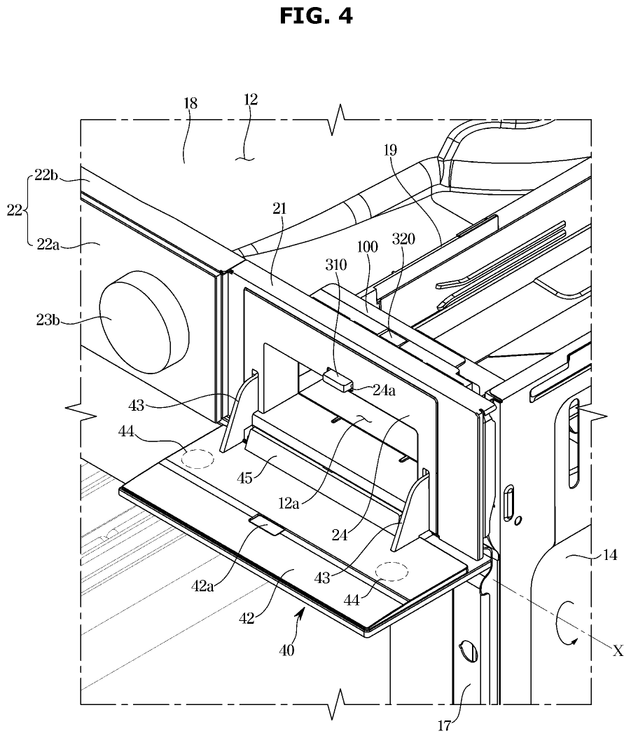

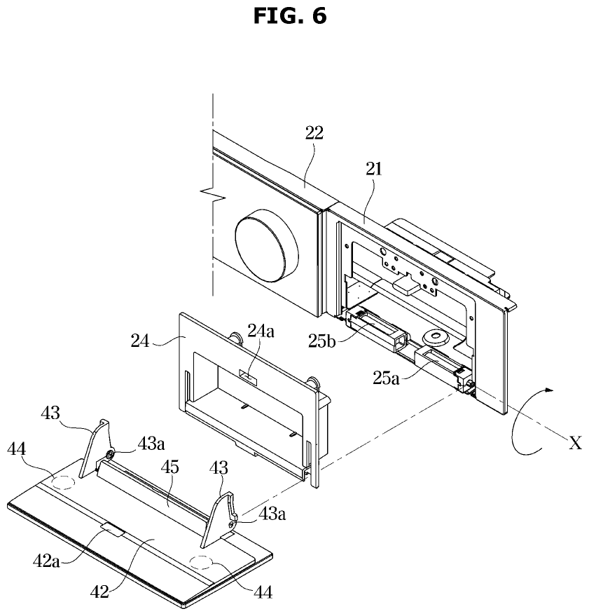

FIG. 4 is an enlarged view of portion A of FIG. 2. FIG. 5 is an enlarged view of portion B of FIG. 3. FIG. 6 is a view illustrating a hinge shaft member of the cooking appliance according to one embodiment of the present disclosure.

Referring to FIGS. 4 to 6, the cooking appliance 1 may include the steam door 40 coupled to the main body 10 to open or close the accommodation chamber 12. The user may open the steam door 40 to withdraw the above-described steam container 51 from the accommodation chamber 12 or may close the steam door 40 after inserting the steam container 51 into the accommodation chamber 12.

The steam door 40 may be disposed on the front surface of the cooking appliance 1. In other words, the opening 12a of the accommodation chamber 12 may be provided in the front of the cooking appliance 1, and the steam door 40 may be provided to be disposed at the front of the opening 12a of the accommodation chamber 12 to open or close the opening 12a.

As the accommodation chamber 12 is disposed at the upper portion of the cooking appliance 1, the steam door 40 may also be disposed at the upper portion of the cooking appliance 1. That is, the steam door 40 may be disposed above the cooking chamber 11 and disposed above the cooking chamber door 30. However, the present disclosure is not limited thereto, and the steam door 40 may be disposed in various other ways to correspond to the position of the accommodation chamber 12 and the position of the opening 12a of the accommodation chamber 12.

The steam door 40 may be connected to the main body 10 by a steam door hinge 43. Specifically, the steam door 40 may be rotatably coupled to the main body 10 by the steam door hinge 43.

As illustrated in FIGS. 4 to 6, the outer frame 20 may cover one surface of the accommodation chamber 12 and form the opening 12a of the accommodation chamber 12, and the outer frame 20 may include a first frame portion 21 provided to be covered by the steam door 40 and a second frame portion 22 disposed adjacent to the first frame portion 21. That is, the first frame portion 21 corresponds to the steam door 40. Details of the first frame portion 21 and the second frame portion 22 will be described below.

The main body 10 may include a door bracket 24 provided on the outer frame 20, and the steam door 40 may be coupled to the door bracket 24 by the steam door hinge 43. The door bracket 24 may be coupled to the first frame portion 21.

The steam door hinge 43 may be coupled to lower ends of both sides of the door bracket 24, and accordingly, an axis of rotation X of the steam door 40 may be formed to be parallel to the lower ends of the door bracket 24. However, the present disclosure is not limited thereto, and the axis of rotation of the steam door 40 may be formed in various other directions, and the steam door 40 may rotate and be opened or closed in various ways.

The outer frame 20 may include hinge shaft members 25a and 25b to which the steam door hinge 43 is coupled to form the axis of rotation of the steam door 40. The hinge shaft members 25a and 25b may be coupled to a hinge hole 43a of the steam door hinge 43 and fixed to the first frame portion 21. The steam door hinge 43 may be provided to be coupled to the hinge shaft members 25a and 25b and be rotatable relative to the first frame portion 21.

A damper (not illustrated) provided to allow the steam door 40 to be opened or closed at a slow speed (e.g., a speed damper) when being opened or closed may be provided on inner sides of the hinge shaft members 25a and 25b.

Specifically, the damper of the hinge shaft members 25a and 25b may include a torsion spring (not illustrated), and the torsion spring of the damper may not be fixed on the inner sides of the hinge shaft members 25a and 25b. In other words, the torsion spring of the damper may be provided to, upon opening of the steam door 40, rotate together about the X-axis on the inner sides of the hinge shaft members 25a and 25b. Here, the rotation of the torsion spring of the damper upon opening of the steam door 40 may be resisted by a fluid (not illustrated), such as a lubricating oil, provided on the inner sides of the hinge shaft members 25a and 25b. According to such a configuration, when being opened, the steam door 40 may be slowly opened due to the damper of the hinge shaft members 25a and 25b.

The hinge shaft members 25a and 25b may include a hinge elastic member (not illustrated) configured to provide an elastic force to correspond to the damper and overcome resistance due to the damper upon closing of the steam door 40. The hinge elastic member may be disposed on the inner sides of the hinge shaft members 25a and 25b and may include a torsion spring (not illustrated). The torsion spring of the hinge elastic member may be provided to be fixed to the inner sides of the hinge shaft members 25a and 25b and be elastically deformable according to rotation of the steam door 40.

The hinge shaft members 25a and 25b may be provided as a plurality of hinge shaft members 25a and 25b. The above-described damper (not illustrated) may be provided on at least some of the plurality of hinge shaft members 25a and 25b, and the hinge elastic member (not illustrated) may be provided on the rest of the plurality of hinge shaft members 25a and 25b. However, the present disclosure is not limited thereto, and the damper or the hinge elastic member may be provided on all of the plurality of hinge shaft members 25a and 25b. Further, the hinge shaft members 25a and 25b may be provided as a single hinge shaft member.

According to the above configuration, the hinge shaft members 25a and 25b may be provided to include the damper and allow the steam door 40 to be slowly opened due to resistance of the damper when being opened due to a door pusher 310. Also, the hinge shaft members 25a and 25b may include the hinge elastic member and allow the user to, when closing the steam door 40, easily close the steam door 40 despite the resistance of the damper.

However, as described above, the steam door 40 may be rotatably coupled in various other ways to the main body 10 by the steam door hinge 43 and is not necessarily limited to including components such as the damper or the hinge elastic member.

The door bracket 24 may form the opening 12a of the accommodation chamber 12 and may be provided to be covered by the steam door 40 when the steam door 40 is closed. Specifically, the door bracket 24 may be covered by an inner surface 42 of the steam door 40 when the steam door 40 is closed.

The steam door 40 may include a magnet 44. At least a portion of the first frame portion 21 and the door bracket 24 of the outer frame 20 that faces the magnet 44 of the steam door 40 may be provided to have a magnetism, and the steam door 40 may maintain a closed state due to an attractive force between the magnet 44 and the first frame portion 21 or the door bracket 24.

The cooking appliance 1 may include the door pusher 310 provided to come in contact with the steam door 40 upon closing of the steam door 40.

Specifically, the cooking appliance 1 may include a door pusher assembly 300 provided to open the steam door 40, and the door pusher assembly 300 may include the door pusher 310 and a support 320 configured to support the door pusher 310.

The door pusher 310 may be provided to pass through the main body 10 and may be provided to protrude from the support frame 100 which will be described below. In other words, the door pusher 310 may be provided to have at least a portion protruding from the accommodation chamber 12 and to come in contact with the steam door 40 upon closing of the steam door 40.

Specifically, the door bracket 24 may have a pusher hole 24a formed therein for the door pusher 310 to pass therethrough, and the door pusher 310 may be provided to pass through the pusher hole 24a and come in contact with the inner surface 42 of the steam door 40. However, the present disclosure is not limited thereto, and the door pusher 310 may be provided to pass through a component of the main body 10 other than the door bracket 24 and come in contact with the steam door 40.

A door groove 42a including a concave shape may be provided in the inner surface 42 of the steam door 40, and the door groove 42a may be provided to accommodate an end portion (e.g., a distal end) of the door pusher 310. In this case, the door pusher 310 may come in contact with the door groove 42a when the steam door 40 is closed.

The door pusher 310 may be provided to be movable relative to the support frame 100, and the door pusher 310 may be provided to, when moving from the support frame 100 toward the steam door 40, press the steam door 40 so that the steam door 40 is opened.

Specifically, when the steam door 40 is closed, the door pusher 310 may be provided to remain in contact with the inner surface 42 of the steam door 40 while positioned at a side adjacent to the support frame 100. Then, the door pusher 310 may be provided to, as the user presses an outer surface 41 of the steam door 40, move from the side adjacent to the support frame 100 toward a side adjacent to the steam door 40 and press the inner surface 42 of the steam door 40 so that the steam door 40 is opened.

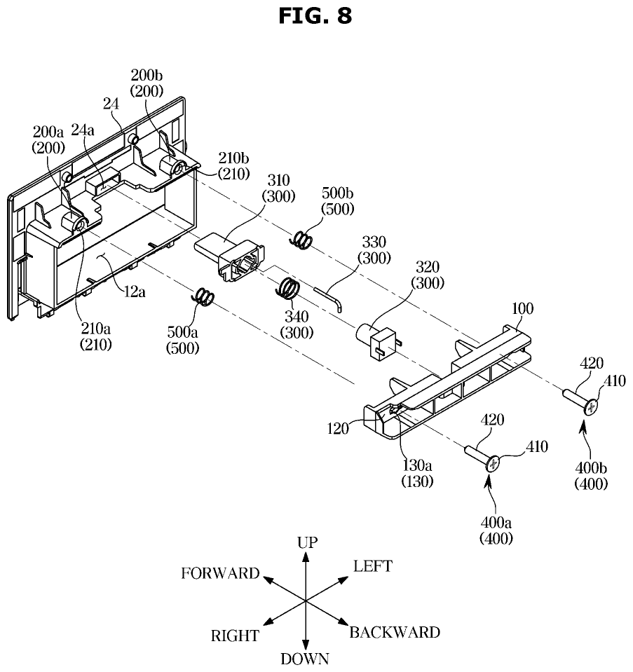

The door pusher assembly 300 may include a pusher spring 340 (see FIG. 8) disposed between the door pusher 310 and the support 320, and accordingly, the door pusher 310 may be provided to be movable while elastically supported by the support 320.

A specific configuration and operation of the door pusher assembly 300 provided to open the steam door 40 will be described below.

However, the steam door 40 may be opened or closed in various ways different from the above description. For example, the steam door 40 may be opened or closed by electronic control. As an example, the door pusher assembly 300 may be provided to receive power from an electronically-controlled driving source (not illustrated) and press the steam door 40, and in this case, the steam door 40 may be automatically opened.

Alternatively, the steam door 40 may include a handle (not illustrated) formed to be gripped by the user to open the steam door 40. In this case, the door pusher assembly 300 may not be necessary for the purpose of opening the steam door 40, but the door pusher assembly 300 may be provided for the purpose of, as will be described below, adjusting the position of the steam door 40 by coming in contact with the steam door 40 when the steam door 40 is closed. That is, the door pusher 310 may be supported by the support frame 100 and may refer to various components provided to come in contact with the steam door 40 when the steam door 40 is closed.

Hereinafter, for convenience of description, description will be given assuming that the door pusher 310 is provided to be movable in the front-rear direction and opens the steam door 40 by pressing the steam door 40.

The steam door 40 may include a door guide 45 formed to protrude from the inner surface 42. The door guide 45 may perform a function of guiding insertion or withdrawal of the steam container 51.

Different from the above description, the opening 12a of the accommodation chamber 12 may be opened or closed for a purpose other than the insertion or withdrawal of the steam container 51. For example, a container (not illustrated) configured to store content other than the water for steam generation may be provided inside the accommodation chamber 12. Examples of the content that may be stored in the corresponding container include water not intended for use in steam generation, an edible oil, a spice, and the like. The container configured to store such content may be disposed in the accommodation chamber 12 like the above-described steam container 51 and may be provided to be withdrawn and inserted through the opening 12a of the accommodation chamber 12.

In such a case, the cooking appliance 1 may include a door 40 coupled to the main body 10 to open or close the opening 12a of the accommodation chamber 12. The door 40 may not be referred to as a steam door due to a purpose thereof, but opening/closing methods thereof may be the same as those described above in relation to the steam door 40.

Hereinafter, for convenience of description, description will be given assuming that the container disposed in the accommodation chamber 12 is the steam container 51, and the door opening or closing the opening 12a of the accommodation chamber 12 is the steam door 40.

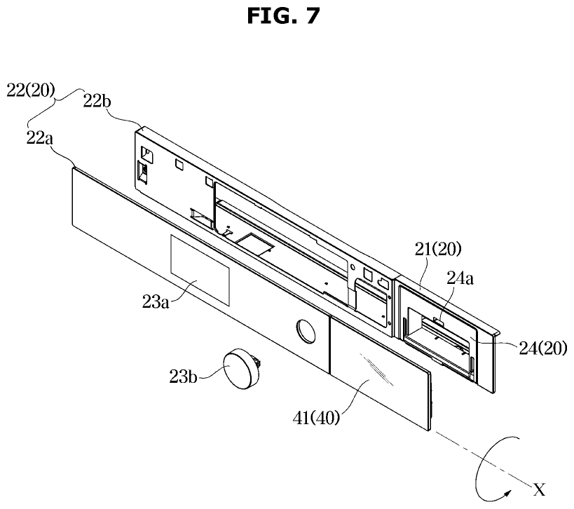

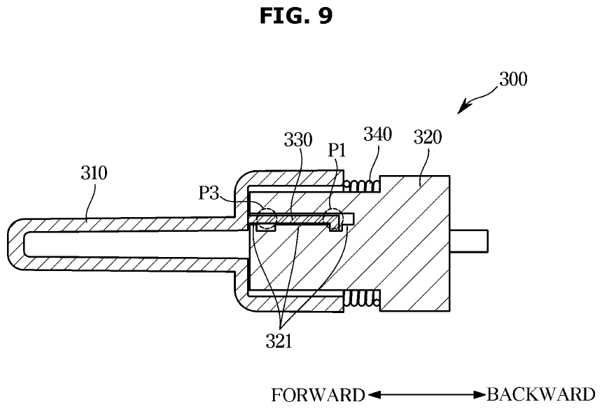

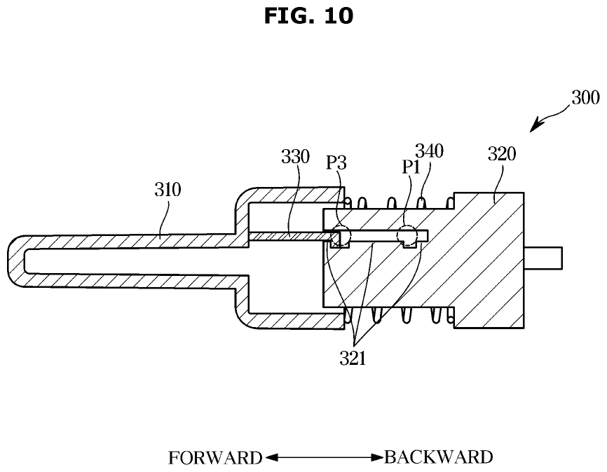

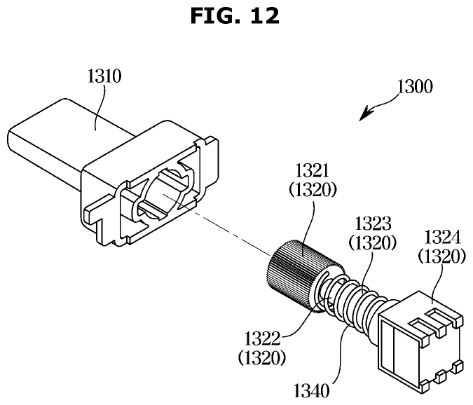

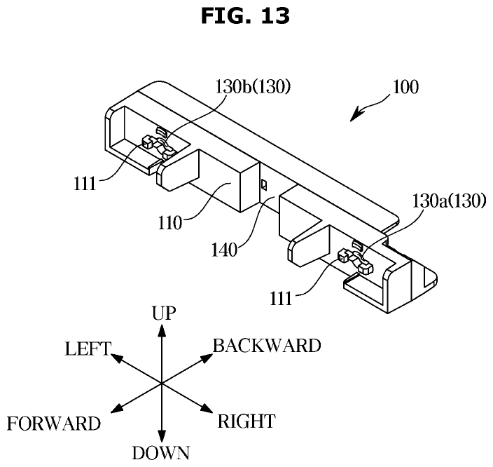

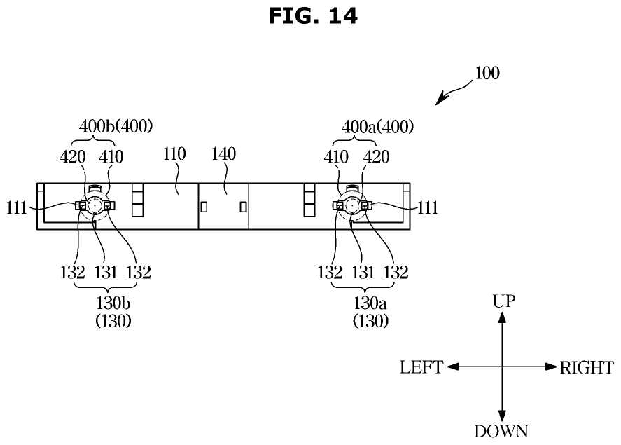

FIG. 7 is a view illustrating the outer frame 20 and the steam door 40 of the cooking appliance 1 according to one embodiment of the present disclosure. FIG. 8 is an exploded view illustrating the coupling relationship of the frame fastening portion 200, the support frame 100, the door pusher 310, and the adjustment member 400 of the cooking appliance 1 according to one embodiment of the present disclosure. FIGS. 9 to 11 are views illustrating the door pusher assembly 300 of the cooking appliance according 1 to one embodiment of the present disclosure. FIG. 12 is a view illustrating a door pusher assembly 300 according to another embodiment of the present disclosure. FIG. 13 is a perspective view illustrating the support frame 100 of the cooking appliance 1 according to one embodiment of the present disclosure. FIG. 14 is a view of the support frame 100 of FIG. 13 from the front.

Referring to FIGS. 7 to 14, the main body 10 may include the outer frame 20 configured to cover one surface of the accommodation chamber 12. The outer frame 20 may be disposed on the front surface of the main body 10, but the present disclosure is not limited thereto.

The outer frame 20 may include the first frame portion 21 provided to be covered by the steam door 40 and the second frame portion 22 disposed adjacent to the first frame portion 21. The first frame portion 21 and the second frame portion 22 may extend in parallel along one surface of the accommodation chamber 12, at a same side of the accommodation chamber 12. The first frame portion 21 and the second frame portion 22 may be coupled to each other.

The opening 12a of the accommodation chamber 12 may be provided in the first frame portion 21. The door bracket 24 may be provided at the first frame portion 21, and the steam door 40 may be rotatably coupled thereto.

The door bracket 24 may be coupled to the first frame portion 21 and fixed to the first frame portion 21. The door bracket 24 and the first frame portion 21 may be separately formed and fixed to each other as illustrated in FIGS. 7 and 8, but the present disclosure is not limited thereto. The first frame portion 21 and the door bracket 24 may be integrally formed.

The above-described display device 23a, manipulation device 23b, and control PCB (not illustrated) electrically connected thereto may be provided on the second frame portion 22.

The second frame portion 22 may include a control frame 22b connected to the first frame portion 21, and a control cover 22a configured to cover the control frame 22b. The control cover 22a may be coupled to the control frame 22b and cover the control frame 22b.

The control frame 22b may accommodate electronic components, such as the control PCB, for functions of the display device 23a or the manipulation device 23b. The control cover 22a may form an outer surface of the second frame portion 22. However, the present disclosure is not limited thereto, and the configuration of the second frame portion 22 may be formed in various other ways as long as the second frame portion 22 can cover one surface of the accommodation chamber 12 together with the first frame portion 21. The second frame portion 22 may be formed as one body without the control cover 22a and the control frame 22b being distinguished from each other.

When the cooking appliance 1 is viewed from the front, the second frame portion 22 and the steam door 40 may cover one surface of the accommodation chamber 12 and form an exterior of the cooking appliance 1. The control cover 22a and the steam door 40 may be coplanar with each other, without being limited thereto Accordingly, there is a demand to improve the external quality of the cooking appliance 1 by arranging the outer surface of the second frame portion 22 and the outer surface of the steam door 40 side by side.

Accordingly, the outer frame 20 may be formed to be stepped so that the second frame portion 22 protrudes more outward (e.g., further from the accommodation chamber 12) than the first frame portion 21. That is, the outer surface of the second frame portion 22 may be positioned in front of the outer surface of the first frame portion 21, where the outer surface is furthest from the accommodation chamber 12.

In this case, a step difference between the second frame portion 22 and the first frame portion 21 may correspond to a sum of a thickness of the steam door 40 and a distance at which the inner surface 42 of the steam door 40 is spaced apart from the outer surface of the first frame portion 21. In this case, when the steam door 40 is closed and covers the first frame portion 21, the outer surface of the second frame portion 22 and the outer surface of the steam door 40 may be disposed side by side. In other words, the outer surface of the second frame portion 22 and the outer surface of the steam door 40 may be disposed side by side as if forming a single plane (e.g., coplanar) and provide a sense of unity in appearance to the user looking at them.

However, since the outer frame 20 is formed so that a step difference occurs between the first frame portion 21 and the second frame portion 22, an error may occur in the step difference between the first frame portion 21 and the second frame portion 22 due to reasons such as an occurrence of bending between the first frame portion 21 and the second frame portion 22. The error may occur more easily in a case in which the first frame portion 21 and the second frame portion 22 are separately formed and then coupled to each other during manufacturing.

This may also be the case when the second frame portion 22 is configured to include the control frame 22b connected to the first frame portion 21 and the control cover 22a covering the control frame 22b. Although the control frame 22b is integrally formed with the first frame portion 21, the steam door 40 covering the first frame portion 21 may be thicker than the control cover 22a covering the control frame 22b and may protrude more outward due to being coupled to the door bracket 24 by the steam door hinge 43. That is, a distance between the outer surface of the first frame portion 21 and the outer surface of the steam door 40 may be larger than a distance between the outer surface of the control cover 22a and the outer surface of the control frame 22b. Accordingly, the control frame 22b may be formed to be stepped to protrude more outward than the first frame portion 21.

Due to such a reason, a step difference may occur on the exterior between the second frame portion 22 and the steam door 40 in a state in which the steam door 40 covers the first frame portion 21. Further, a step difference may occur on the exterior between the second frame portion 22 and the steam door 40 due to various other reasons such as an error occurring in a coupling portion when the steam door 40 is rotatably coupled to the door bracket 24 by the steam door hinge 43 or an error occurring in a coupling portion when the door bracket 24 is coupled to the first frame portion 21.

In order to address such a problem, the cooking appliance 1 is provided to include the adjustment member 400, which will be described below, to adjust the step difference between the steam door 40 and the second frame portion 22. Details of the adjustment member 400 will be described below.

As illustrated in FIG. 8, the cooking appliance 1 may include the door pusher assembly 300 including the door pusher 310, the support frame 100 configured to support the door pusher assembly 300, and the adjustment member 400 provided to fasten the support frame 100 to the main body 10. One component of the main body 10 to which the support frame 100 is fastened by the adjustment member 400 may be referred to as the frame fastening portion 200.

In other words, the cooking appliance 1 may include the support frame 100 disposed in the accommodation chamber 12, the door pusher assembly 300 including the door pusher 310 disposed on the support frame 100, and the adjustment member 400. The main body 10 may include the frame fastening portion 200, and the support frame 100 may be fastened to the frame fastening portion 200 by the adjustment member 400.

The door pusher assembly 300 may have at least one portion disposed in the accommodation chamber 12, and the at least one portion may be provided to protrude from the accommodation chamber 12 (e.g., be outside of the accommodation chamber 12) and come in contact with the steam door 40 when the steam door 40 is closed. The door pusher assembly 300 may be provided to allow the steam door 40 to open or close the accommodation chamber 12.

The door pusher assembly 300 may include the door pusher 310, the support 320 coupled to the support frame 100 to support the door pusher 310, a movement pin 330 coupled to the door pusher 310 to guide movement of the door pusher 310 relative to the support 320, and the pusher spring 340 disposed between the door pusher 310 and the support 320.

The door pusher 310 may be provided to come in contact with the steam door 40 upon closing of the steam door 40. The door pusher 310 may be provided to come in contact with the inner surface 42 of the steam door 40 facing the main body 10 upon closing of the steam door 40 and may pass through the main body 10 to protrude from the accommodation chamber 12.

Specifically, the door pusher 310 may pass through the pusher hole 24a of the door bracket 24, but a portion of the main body 10 through which the door pusher 310 passes is not limited thereto.

The door pusher 310 may be supported by the support frame 100. In other words, the door pusher 310 may protrude from the support frame 100 and pass through the main body 10. As will be described below, the door pusher 310 may be provided to vary the position of the steam door 40 according to a change in the position of the support frame 100.

The door pusher 310 may be provided to be movable relative to the support frame 100. The door pusher 310 may be provided to move toward the steam door or move toward a side opposite to the steam door 40, relative to the support frame 100. The door pusher 310 may be provided to, when moving from the support frame 100 toward the steam door 40, press the steam door 40 so that the steam door 40 is opened.

For example, as illustrated in FIGS. 8 to 11, the door pusher 310 may be provided to be movable in the front-rear direction from the support frame 100 and may, when moving forward from the support frame 100, press the steam door 40 forward and cause the steam door 40 to open. However, conversely, in the case of closing the steam door 40, the door pusher 310 may move backward toward the support frame 100.

The support 320 may be coupled to the support frame 100 and support the door pusher 310. Specifically, the support 320 may be fixed to a door pusher coupling portion 140 provided on the support frame 100 and may movably support the door pusher 310 by the movement pin 330 and the pusher spring 340.

The support 320 may include a pin guide 321 provided to guide movement of the door pusher 310. The support 320 may have a groove formed in a side facing the door pusher 310, and the pin guide 321 may be formed on an inner side of the groove of the support 320.

The movement pin 330 may be provided to be fixed to the door pusher 310 and be guided by the pin guide 321 to allow the door pusher 310 to be movable relative to the support 320. The movement pin 330 may have one end fixed to an inner portion of the door pusher 310 and the other end (e.g., a distal end) guided by the pin guide 321. The movement pin 330 may be provided to extend from the one end fixed to the door pusher 310 toward the support 320 and then be bent to be guided by the pin guide 321. However, the movement pin 330 may have various other shapes.

The pusher spring 340 may be disposed between the door pusher 310 and the support 320. The pusher spring 340 may be provided to be fixed to each of the door pusher 310 and the support 320 and be elastically deformable in a direction in which the door pusher 310 moves.

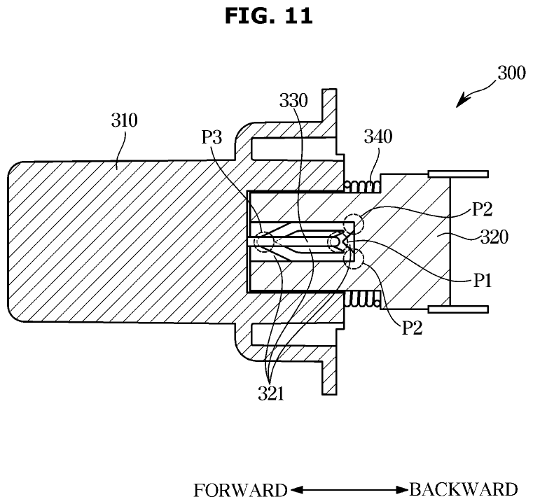

As illustrated in FIGS. 9 and 11, the door pusher 310 may be provided to be adjacent to the support frame 100. Here, the movement pin 330 may be disposed at a first position P1 on an inner side of the support 320, and the pusher spring 340 may be in a compressed state. The movement pin 330 at the first position P1 may dispose the steam door 40 to be closed.

Here, in a case in which the door pusher 310 is pressed due to receiving an external force toward the support frame 100, the movement pin 330 may move to a second position P2 on the inner side of the support 320, like moving from the first position P1, and the pusher spring 340 may be compressed further. In the case in which the door pusher 310 receives an external force toward the support frame 100, for example, in some cases, the inner surface 42 of the steam door 40 may press the door pusher 310 due to the user pressing the outer surface 41 of the steam door 40 which is in a closed state.

Then, in a case in which the external force applied to the door pusher 310 and disposes the movement pin 330 in the second position P2 is removed, the door pusher 310 may receive an elastic force of the pusher spring 340 toward the steam door 40, where the elastic force is biased toward the steam door 40. Here, the movement pin 330 may be guided by the pin guide 321 and move to a third position P3. In the process in which the movement pin 330 moves to the third position P3, the door pusher 310 may press the closed steam door 40 and cause the steam door 40 to open. That is, the movement pin 330 at the third position P3 disposes the steam door 40 to be open.

Conversely, in a case in which, with the steam door 40 opened and the door pusher 310 moved to a side opposite to the support frame 100, the door pusher 310 is pressed due to receiving an external force toward the support frame 100, the movement pin 330 disposed at the third position P3 may be guided by the pin guide 321 and move to the second position P2. Here, the pusher spring 340 may be compressed. An example of the case in which the door pusher 310 receives an external force toward the support frame 100 may include a case in which the user presses the outer surface 41 of the steam door 40 to close the opened steam door 40, and the inner surface 42 of the steam door 40 presses the door pusher 310.

Then, in a case in which the external force applied to the door pusher 310 is removed, the door pusher 310 receives an elastic force of the pusher spring 340, and accordingly, the movement pin 330 may be guided by the pin guide 321 and move to the first position P1. Here, the door pusher 310 stops at a position adjacent to the support frame 100, and the steam door 40 may maintain a closed state.

That is, a distance at which the door pusher 310 protrudes from the position of the support 320 may vary according to the number of times and the force applied when the door pusher 310 is pressed. In other words, the door pusher assembly 300 may be provided to include a structure that allows the movement pin 330 to be locked or unlocked as the door pusher 310 is pressed so that the position of the door pusher 310 varies. In terms of this aspect, the door pusher assembly 300 may be referred to as a push-lock switch 300.

By such a configuration, the door pusher assembly 300 may be provided so that the door pusher 310 is movable relative to the support frame 100 and the steam door 40 may be opened or closed corresponding to a protruding distance of the door pusher 310 from the support 320. Accordingly, the user may easily open or close the steam door 40 just by pressing the outer surface 41 of the steam door 40 and may easily insert or withdraw the steam container 51.

Referring to FIG. 12, a door pusher assembly 1300 according to another embodiment, which is different from the door pusher assembly 300 illustrated in FIGS. 8 to 11, may be provided.

The door pusher assembly 1300 may include a door pusher 1310, a support 1320 configured to movably support the door pusher 1310 and be fixed to the support frame 100, and a pusher spring 1340 configured to elastically support the door pusher 1310.

Unlike the door pusher 310 illustrated in FIGS. 8 to 11, the door pusher 1310 may not have the movement pin 330 provided on an inner side. The door pusher 1310 may include a shape having a hole formed to allow an insertion portion 1321 of the support 1320 to be inserted and coupled.

The support 1320 may include the insertion portion 1321 inserted into the hole of the door pusher 1310 to be coupled to the door pusher 1310. The shape of the insertion portion 1321 may be formed to correspond to the shape of the hole of the door pusher 1310 into which the insertion portion 1321 is inserted. For example, the insertion portion 1321 may include a cylindrical shape. As illustrated in FIG. 12, the insertion portion 1321 may include a protrusion formed on a cylindrical outer circumferential surface and thus be more firmly coupled to the door pusher 1310. The insertion portion 1321 may be provided to move together with the door pusher 1310.

The support 1320 may include a movement bar 1322 configured to movably support the insertion portion 1321 and a support cylinder 1323 configured to movably support the movement bar 1322 which is inserted thereinto. The movement bar 1322 may be provided in the shape of a bar and may be coupled to a side of the insertion portion 1321 that is opposite to the door pusher 1310. The support cylinder 1323 may be provided to include a cylindrical shape having a hollow formed therein, and at least a portion of the movement bar 1322 may be accommodated in the hollow of the support cylinder 1323. The movement bar 1322 may be provided to be further inserted into the back side of the support cylinder 1323 as the door pusher 1310 is pressed.

The support 1320 may include a coupling portion 1324 provided to be coupled to the support frame 100. The shape of the coupling portion 1324 may be provided to be coupled to the door pusher coupling portion 140 of the support frame 100. Alternatively, the door pusher coupling portion 140 of the support frame 100 may have various shapes to correspond to the shape of the coupling portion 1324.

The pusher spring 1340 of the door pusher assembly 1300 may have one end coupled to the insertion portion 1321 and the other end coupled to the support cylinder 1323. Accordingly, when the door pusher 1310 moves toward the support frame 100, a distance between the insertion portion 1321 and the support cylinder 1323 may decrease, and the pusher spring 1340 may be compressed. Conversely, when the door pusher 1310 moves toward the support frame 100, the distance between the insertion portion 1321 and the support cylinder 1323 may increase, and the pusher spring 1340 may be stretched. In this way, the pusher spring 1340 may be provided to be elastically deformable to allow the door pusher 1310 to be elastically supported by the pusher spring 1340. However, the present disclosure is not limited thereto, and the pusher spring 1340 may be coupled to various components of the support 1320 to be elastically deformed according to movement of the door pusher 1310. For example, the pusher spring 1340 may have one end coupled to a side with the movement bar 1322 and the other end coupled to a side with the coupling portion 1324.

The support 1320 may include a structure (not illustrated) provided to allow the movement bar 1322 to be locked or unlocked as the door pusher 1310 is pressed. Specifically, the movement bar 1322 may be provided to be locked or unlocked by a locking structure (not illustrated) provided on an inner side of the support cylinder 1323. In this case, the door pusher 1310, the insertion portion 1321, and the movement bar 1322 may move toward the support frame 100 or move toward the side opposite to the support frame 100 according to the number of times the door pusher 1310 is pressed.

The structure in which the movement bar 1322 is locked or unlocked may include various structures such as a structure similar to the locking structure illustrated in FIGS. 8 to 11.

However, the above description of the door pusher assemblies 300 and 1300 that may each serve as a push-lock switch is only an example, and the configuration of the door pusher assembly 300 may be provided to vary instead of being limited to the above.

The support frame 100 may be provided to support the door pusher 310. The support frame 100 may be disposed in the accommodation chamber 12.

The support frame 100 may be fastened to the main body 10. Specifically, the support frame 100 may be fastened to the frame fastening portion 200 of the main body 10.

The support frame 100 may be provided so that its position relative to the frame fastening portion 200 varies or is variable. Specifically, the support frame 100 may be fastened to the frame fastening portion 200 so that the position of the support frame 100 relative to the frame fastening portion 200 varies due to the adjustment member 400 which will be described below.

The support frame 100 may be fastened to the frame fastening portion 200 on the inner side of the accommodation chamber 12. As illustrated in FIG. 8, the support frame 100 may be disposed behind the door bracket 24. Also, the support frame 100 may be disposed behind the door pusher 310 to support the door pusher 310 to be movable forward and backward. However, the position of the support frame 100 is not limited thereto, and the support frame 100 may be disposed at various other positions according to the position of the opening 12a of the accommodation chamber 12, the shape of the door pusher 310, and the like as long as the support frame 100 is fastened to the frame fastening portion 200 and can support the door pusher 310.

As described above, the frame fastening portion 200 to which the support frame 100 is fastened may be disposed on the door bracket 24. However, the present disclosure is not limited thereto, and the frame fastening portion 200 may be provided at various other positions at which the support frame 100 can be fastened to the frame fastening portion 200 in the main body 10.

The adjustment member 400 may be provided to adjust the position of the support frame 100 relative to the frame fastening portion 200. The adjustment member 400 may fasten the support frame 100 and the frame fastening portion 200 so that a fastening distance between the support frame 100 and the frame fastening portion 200 varies.

The support frame 100 may include a first side 110 facing the frame fastening portion 200, a second side 120 opposite to the first side 110, and a through-hole 130 formed between the first side 110 and the second side 120. In other words, the support frame 100 may include the through-hole 130 formed so that the adjustment member 400 passes through the first side 110 and the second side 120.

The adjustment member 400 may pass through the through-hole 130 of the support frame 100 in a direction from the second side 120 toward the first side 110 and be fastened to the frame fastening portion 200.

The adjustment member 400 may include a fastening head 410 bound to the second side 120 so that the adjustment member 400 is not able to move to the first side 110 and a fastening body 420 provided to pass through the through-hole 130 from the fastening head 410. The fastening head 410 may be provided to be larger than the through-hole 130 and be bound to the second side 120 without passing through the through-hole 130.

The fastening body 420 may pass through the through-hole 130 and be inserted into the frame fastening portion 200. Specifically, the frame fastening portion 200 may include an insertion hole 210 formed in a direction parallel to a direction in which the support frame 100 is fastened by the adjustment member 400, and the fastening body 420 may be inserted into the insertion hole 210.

However, the present disclosure is not limited thereto, and the support frame 100, the frame fastening portion 200, and the adjustment member 400 may be provided in various other ways so that the adjustment member 400 fastens the frame fastening portion 200 and the support frame 100 and adjusts the position of the support frame 100 relative to the frame fastening portion 200. The adjustment member 400 may fasten the support frame 100 and the frame fastening portion 200 by fastening a screw which passes through the support frame 100, but the present disclosure is not limited thereto. For example, the adjustment member 400 may use a method of fastening a clamp or the like and fasten the support frame 100 to the frame fastening portion 200 without passing through the support frame 100.

The adjustment member 400 may be provided so that the fastening distance between the support frame 100 and the frame fastening portion 200 varies or is variable to be set in position. Since the frame fastening portion 200 may have a fixed position, the position of the support frame 100 relative to the frame fastening portion 200 may vary according to a change in the fastening distance between the support frame 100 and the frame fastening portion 200. In other words, the adjustment member 400 may be provided to adjust the position of the support frame 100 relative to the frame fastening portion 200.

In response to a change in the position of the support frame 100 due to the adjustment member 400 varying the fastening distance between the support frame 100 and the frame fastening portion 200, a change may occur in the door pusher 310 supported by the support frame 100. Further, since the door pusher 310 comes in contact with the inner surface 42 of the steam door 40 when the steam door 40 is closed, the position of the steam door 40 may change due to the door pusher 310.

In other words, the adjustment member 400 may fasten the support frame 100 to the frame fastening portion 200 to adjust the position of the door pusher 310 relative to the frame fastening portion 200. In this case, the adjustment member 400 may be provided to change the support frame 100 relative to the first frame portion 21 to, when a step difference occurs on the exterior between the steam door 40 and the second frame portion 22 as described above, adjust the step difference between the steam door 40 and the second frame portion 22. Accordingly, by adjusting a degree of fastening of the adjustment member 400, the external quality of the cooking appliance 1 can be improved.

As illustrated in FIG. 13, the through-hole 130 may be formed to be smaller than a diameter of the fastening head 410 and larger than a diameter of the fastening body 420. Since the through-hole 130 is formed to be smaller than the diameter of the fastening head 410, the fastening head 410 may be bound to the second side 120 so that the adjustment member 400 is not able to move to the first side 110. On the other hand, since the through-hole 130 is formed to be larger than the diameter of the fastening body 420, the fastening body 420 may not be bound to the support frame 100.

Accordingly, the adjustment member 400 may be provided to adjust the fastening distance between the support frame 100 and the frame fastening portion 200 more easily as compared to when the adjustment member 400 passes through the support frame 100 for the fastening body 420 to be bound to the through-hole 130. Further, the adjustment member 400 may be provided to adjust the position of the support frame 100 relative to the frame fastening portion 200 with a higher degree of freedom as compared to when the fastening body 420 is bound to the through-hole 130.

The through-hole 130 may be formed to extend in a direction parallel to the direction of the axis of rotation X of the steam door 40. Specifically, the through-hole 130 may include a central portion 131 and extending portions 132 configured to extend parallel to the direction of the axis of rotation X from both sides of the central portion 131.

In this case, the fastening body 420 may have a high degree of freedom relative to the through-hole 130, especially in the direction parallel to the direction of the axis of rotation X. That is, the adjustment member 400 may easily move relative to the through-hole 130, especially in the direction parallel to the direction of the axis of rotation X.

Accordingly, the adjustment member 400 may be provided to adjust an angle of the support frame 100 relative to the frame fastening portion 200 and may be provided to easily adjust the angle of the support frame 100 especially in the direction parallel to the direction of the axis of rotation X.

The adjustment member 400 may be provided as a plurality of adjustment members. That is, the adjustment member 400 may include a plurality of adjustment members 400a and 400b, and the frame fastening portion 200 may also be provided as a plurality of frame fastening portions to correspond to the plurality of adjustment members 400a and 400b. A plurality of frame fastening portions 200a and 200b may include a plurality of insertion holes 210a and 210b, respectively. Likewise, the support frame 100 may include a plurality of through-holes 130a and 130b.

The plurality of adjustment members 400a and 400b may be provided to independently adjust a distance from each of the plurality of frame fastening portions 200a and 200b to the support frame 100. In other words, the plurality of adjustment members 400a and 400b may be provided to independently adjust a fastening distance of the support frame 100 relative to each of the plurality of frame fastening portions 200a and 200b, and the fastening distances by the plurality of adjustment members 400a and 400b may be the same or different from each other.

For example, one adjustment member 400a of the plurality of adjustment members 400a and 400b may pass through one through-hole 130a of the plurality of through-holes 130a and 130b and be inserted into the insertion hole 210a of one frame fastening portion 200a of the plurality of frame fastening portions 200a and 200b in order to be fastened. Also, the other adjustment member 400b of the plurality of adjustment members 400a and 400b may pass through the other through-hole 130b of the plurality of through-holes 130a and 130b and be inserted into the insertion hole 210b of the other frame fastening portion 200b of the plurality of frame fastening portions 200a and 200b in order to be fastened. Here, each of the plurality of adjustment members 400a and 400b may be provided to independently adjust the fastening distance. In other words, a distance from the one frame fastening portion 200a of the plurality of frame fastening portions 200a and 200b to the one through-hole 130a of the plurality of through-holes 130a and 130b may be independently adjusted from a distance from the other frame fastening portion 200b of the plurality of frame fastening portions 200a and 200b to the other through-hole 130b of the plurality of through-holes 130a and 130b.

The plurality of adjustment members 400a and 400b may be disposed in the direction of the axis of rotation X of the steam door 40.

Accordingly, the plurality of adjustment members 400a and 400b may be provided to adjust the angle of the support frame 100 relative to the frame fastening portion 200 and may be provided to easily adjust the angle of the support frame 100 especially in the direction parallel to the direction of the axis of rotation X.

The door pusher 310 may be disposed between the plurality of adjustment members 400a and 400b. In this case, the door pusher 310 may rotate in different directions according to whether the fastening distance is adjusted by the one adjustment member 400a or the other adjustment member 400b of the plurality of adjustment members 400a and 400b, and an angle of the steam door 40 relative to the first frame portion 21 may be more easily adjusted.

However, the present disclosure is not limited thereto, and the adjustment member 400 may be provided in various other ways. For example, the adjustment member 400 may be provided as a single adjustment member. Even in this case, the fastening distance between the support frame 100 and the frame fastening portion 200 may be adjusted by the adjustment member 400. Also, even when the adjustment member 400 is provided as a single adjustment member, the single adjustment member 400 may adjust the angle of the support frame 100 relative to the frame fastening portion 200 as long as one side of the support frame 100 is fixed to the frame fastening portion 200.

The cooking appliance 1 may further include an elastic member 500 disposed between the main body 10 and the support frame 100 so that the support frame 100 is elastically supported relative to the main body 10.

The elastic member 500 may be disposed between the frame fastening portion 200 and one surface of the support frame 100 that is adjacent to the frame fastening portion 200. That is, the elastic member 500 may be disposed between the frame fastening portion 200 and the first side 110 of the support frame 100.

The elastic member 500 may have one end coupled to the frame fastening portion 200. A portion of the frame fastening portion 200 to which the one end of the elastic member 500 is coupled may be disposed radially outward from the insertion hole 210. The other end of the elastic member 500 may be coupled to an elastic member coupling portion 111 provided on the first side 110 of the support frame 100.

The elastic member 500 may be formed to be elastically deformable in a direction parallel to a direction in which the frame fastening portion 200 and the support frame 100 are fastened. Since the one end of the elastic member 500 is coupled to the frame fastening portion 200, the elastic member 500 may be elastically deformed and support the support frame 100 when the position of the support frame 100 moves relative to the frame fastening portion 200.

However, the present disclosure is not limited thereto, and the elastic member 500 may be disposed between the support frame 100 and another component of the main body 10. For example, the elastic member 500 may extend backward from the second side 120 of the support frame 100 and be coupled to the main body 10.

The support frame 100 may receive an elastic force from the elastic member 500 in the direction parallel to the direction in which the support frame 100 and the frame fastening portion 200 are fastened. For example, in a case in which the fastening distance between the support frame 100 and the frame fastening portion 200 decreases by the adjustment member 400, the support frame 100 may receive an elastic force from the elastic member 500 in a direction opposite to a direction toward the frame fastening portion 200.

The elastic member 500 may extend along the adjustment member 400. The elastic member 500 may extend in the direction parallel to the direction in which the support frame 100 is fastened to the frame fastening portion 200 by the adjustment member 400.

The elastic member 500 may extend to surround the fastening body 420 and may be disposed between the frame fastening portion 200 and the first side 110 of the support frame 100.

The elastic member 500 may include a coil (e.g., an elastic coil) disposed between the first side 110 and the frame fastening portion 200. The elastic member 500 may be a compression spring.

The elastic member 500 may be provided as a plurality of elastic members. A plurality of elastic members 500a and 500b may be provided to correspond to the plurality of adjustment members 400a and 400b. However, the present disclosure is not limited thereto, and the number of elastic members 500 may vary.

Since the cooking appliance 1 includes the elastic member 500, the support frame 100 can be elastically supported by the elastic member 500 and be more stably supported relative to the main body 10 when the position of the support frame 100 relative to the frame fastening portion 200 is adjusted by the adjustment member 400.

Further, when the adjustment member 400 adjusts the fastening distance between the support frame 100 and the frame fastening portion 200 to increase, the elastic member 500 may press the support frame 100 toward the side opposite to the frame fastening portion 200 so that the support frame 100 comes in close contact with the adjustment member 400 which has moved backward. That is, the elastic member 500 may allow the support frame 100 to be bound to the adjustment member 400 by an elastic force.

However, since the function of adjusting the position of the support frame 100 is performed by the adjustment member 400, and the elastic member 500 may not directly perform the function of adjusting the position of the support frame 100, the cooking appliance 1 according to the spirit of the present disclosure is not limited to including the elastic member 500.

In order to adjust the position of the steam door 40 using the adjustment member 400, the user may separate the top panel 13 and access the accommodation chamber 12. The user may adjust the adjustment member 400 to adjust the fastening distance between the support frame 100 and the frame fastening portion 200 and adjust the position of the support frame 100 relative to the frame fastening portion 200.

For example, the support frame 100 may be fastened to the frame fastening portion 200 in a direction from the back to the front by the adjustment member 400, and the user may use a fastening tool (not illustrated) to adjust the fastening head 410 of the adjustment member 400 from behind. The adjustment member 400 may adjust the fastening distance between the support frame 100 and the frame fastening portion 200 by the user rotating the fastening head 410 using a fastening tool such as a screwdriver.

However, the method of fastening the support frame 100 and the frame fastening portion 200, and the method of adjusting the fastening distance therebetween by the adjustment member 400 are not limited to the above and may vary.

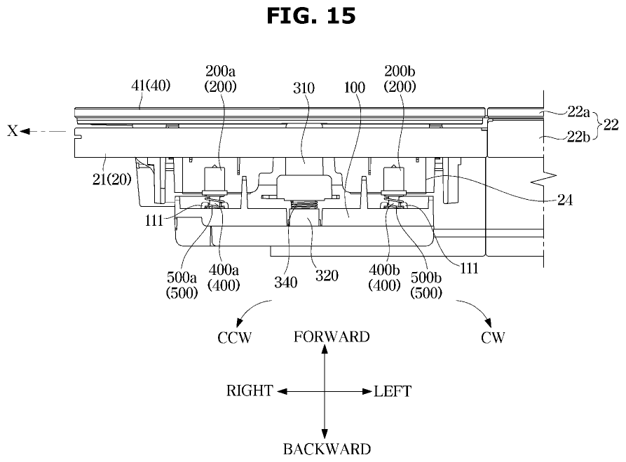

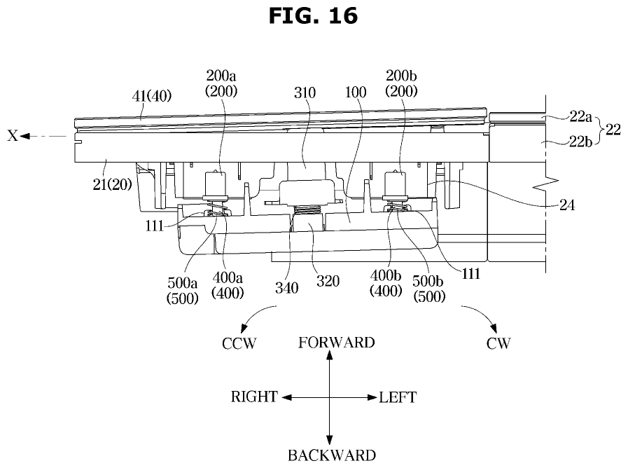

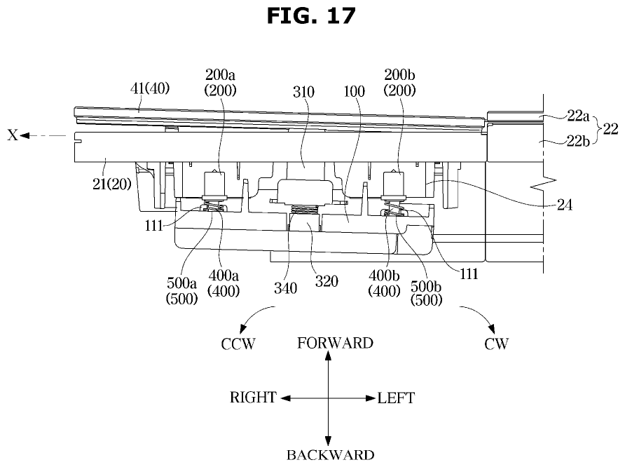

FIG. 15 is a view illustrating a state in which the support frame 100 is fastened to the frame fastening portion 200 in the cooking appliance 1 according to one embodiment of the present disclosure that is viewed from the top. FIGS. 16 and 17 are views illustrating a state in which the position of the steam door 40 is adjusted using the adjustment member 400 in the cooking appliance 1 of FIG. 15.

Referring to FIGS. 15 to 17, a process in which the position of the steam door 40 is adjusted according to one embodiment of the present disclosure will be described.

Referring to FIG. 15, since the outer frame 20 is formed to be stepped so that the second frame portion 22 protrudes more outward than the first frame portion 21 relative to the accommodation chamber 12, the outer surfaces of the steam door 40 and the second frame portion 22 may be disposed side by side along the left-right directions. Accordingly, the cooking appliance 1 can provide a sense of unity to the user, and the external quality of appearance of the cooking appliance 1 can be improved. FIG. 15 shows of the steam door 40 and the second frame portion 22 being coplanar with each other.

However, as described above, a step difference may occur between the steam door 40 and the second frame portion 22 due to various reasons. For example, as illustrated in FIG. 16, the steam door 40 may be tilted relative to the first frame portion 21 so that the right side of the steam door 40 is closer to the back of the cooking appliance 1 than the left side thereof. Alternatively, as illustrated in FIG. 17, the steam door 40 may be tilted relative to the first frame portion 21 so that the left side of the steam door 40 is closer to the back of the cooking appliance 1 than the right side thereof. In this case, the external quality of the cooking appliance 1 may be degraded due to the step difference between the steam door 40 and the second frame portion 22.

In the case of FIG. 16, a fastening distance between the support frame 100 and the frame fastening portion 200a may be decreased by one adjustment member 400a of the plurality of adjustment members 400, or a fastening distance between the support frame 100 and the frame fastening portion 200b may be increased by the other adjustment member 400b of the plurality of adjustment members 400. In this case, the support frame 100 and the door pusher 310 supported thereby may rotate together in a clockwise direction CW based on FIG. 16, and the steam door 40 may also rotate in the same direction CW together with rotation of t the support frame 100 and the door pusher 310 supported thereby. Accordingly, the right side of the steam door 40 moves forward or the left side of the steam door 40 moves backward, and the step difference with the second frame portion 22 may be adjusted. An adjusted step difference disposes the steam door 40 and the second frame portion 22 being coplanar with each other.

In the case of FIG. 17, a fastening distance between the support frame 100 and the frame fastening portion 200a may be decreased by one adjustment member 400b of the plurality of adjustment members 400, or a fastening distance between the support frame 100 and the frame fastening portion 200b may be increased by the other adjustment member 400a of the plurality of adjustment members 400. In this case, the support frame 100 and the door pusher 310 supported thereby may rotate in a counter clockwise direction CCW based on FIG. 17, and the steam door 40 may also rotate in the same direction CCW. Accordingly, the left side of the steam door 40 moves forward or the right side of the steam door 40 moves backward, and the step difference with the second frame portion 22 may be adjusted. Similarly, an adjusted step difference disposes the steam door 40 and the second frame portion 22 being coplanar with each other.

In an embodiment, a cooking appliance includes a main body defining a cooking chamber, and an accommodation chamber which is separated from the cooking chamber and is open to outside the main body at an opening of the main body, a steam container which is accommodated inside the accommodation chamber and accessible from outside of the accommodation chamber, via the opening, where the steam container stores a material, a steam supplier which connects the steam container and the cooking chamber to each other, where the steam supplier generates steam from the material in the steam container and supplies generated steam to the cooking chamber, a door support frame (e.g., door bracket 24) which supports the door and is fixed to the main body, a door which is coupled to main body, where the door opens and closes the accommodation chamber at the opening, a door pusher support frame (e.g., support frame 100) which is inside of the accommodation chamber, connected to the door support frame and moveable relative to the door support frame, a door pusher connected to the door pusher support frame and provided to come in contact with the door upon closing of the door, and a position adjuster (e.g., one or more, for example, of 200a, 200b, 400, and 500) which connects the door support frame to the door pusher support frame and adjusts a position of the door relative to the door support frame. The door which closes the accommodation chamber disposes the door pusher in contact with the door.

The position adjuster may include a fastening head which is bound to the second side to restrict movement of the position adjuster to the first side via the through-hole, and a fastening body which is extended from the fastening head, passes through the through-hole of the door pusher support frame, and extends into the door support frame to connect the door support frame to the door pusher support frame. The through-hole 130 of the door pusher support frame is smaller than the fastening head and larger than the fastening body. The through-hole of the door pusher support frame has a major dimension which extends parallel to the axis of rotation, for example, along the left-right direction in FIG. 8.

Referring to FIGS. 15 to 17, for example, the position adjuster is provided in plural including a plurality of adjustment members 400a and 400b, the door support frame includes a plurality of frame fastening portions 200a and 200b which correspond to the plurality of adjustment members, and distances between the door pusher support frame (e.g., support frame 100), and the door support frame (e.g., the door bracket 24) at each of the plurality of frame fastening portions, respectively, are independently adjusted by the plurality of adjustment members of the position adjuster.

The main body defines the opening 12a at a side of the cooking appliance 1 (e.g., the front side). At the side of the cooking appliance, the main body includes an outer frame 20. The outer frame 20 includes a first frame portion 21 which defines the opening through which the steam container is accessible from the outside of the accommodation chamber, a second frame portion 22 which is adjacent to the first frame portion along the side of the cooking appliance and protrudes further from the accommodation chamber than the first frame portion (e.g., in the forward direction), and a stepped portion formed by the first frame portion and the second frame portion (FIG. 6 shows a step between 22 and 21). The position adjuster adjusts a planar position of the door to compensate the stepped portion of the outer frame. Referring to FIG. 15, for example, the door in an adjusted position is disposed in a plane defined along the left-right direction and the up-down direction, such as to be coplanar with a front outer surface of the second frame portion 22. In FIGS. 16 and 17, a planar position of the door is adjustable for removing step difference.

Referring to FIGS. 6 and 15 to 17, for example, the door support frame (e.g., the door bracket 24) extends along the outside of the first frame portion 21, through the opening of the first frame portion 21 and into the accommodation chamber 12. Adjustment of the planar position of the door includes tilting the position of the door by the position adjuster together with the door pusher support frame within the opening of the first frame portion, to compensate the stepped portion of the outer frame. FIGS. 16 and 17 show the door is movable relative to the door bracket 24. The position adjuster (e.g., one or more, for example, of 200a, 200b, 400, and 500) connects the door support frame (e.g., the door bracket 24) to the door pusher support frame (e.g., the support frame 100), inside the accommodation chamber.

In an embodiment, a main body defining a cooking chamber, a food-treatment material chamber (e.g., an accommodation chamber 12) which is separated from the cooking chamber and open to outside the main body, at an opening of the main body, and an outer surface which has a stepped portion at the opening (FIG. 6 shows a stepped portion of outer surfaces of 22 and 21), a food-treatment container (e.g., steam container 51) which is accommodated in the food-treatment material chamber and accessible from outside of the food-treatment material chamber, via the opening, where the food-treatment container stores a food-treatment material (e.g., water, an edible oil, a spice, and the like), a food-treatment material supplier (e.g., stem pump module 52) which supplies the food-treatment material from the food-treatment material chamber to the cooking chamber, a door (e.g., a steam door 40) which is coupled to main body, and opens and closes the food-treatment material chamber, at the opening, and a door adjuster which is connected to the door, extends along the outer surface of the main body at the opening, and adjusts a planar position of the door at the opening to compensate the stepped portion of the outer surface of the main body (e.g., a collection of the components shown in FIG. 8, for example, including the door bracket 24 to the support frame 100 and various intervening elements).

In an embodiment, the door adjuster includes a door support frame (e.g., door bracket 24) which extends along the outer surface of the main body, at the opening, and through the opening of the main body, to be disposed in the food-treatment material chamber, and maintains a fixed position relative to the outer surface, and supports the door. The door is connected to the door support frame and moveable relative to the door support frame (FIGS. 15 to 17, for example). The door adjuster further includes a support frame 100 moveable relative to the door support frame within the food-treatment material chamber, a door pusher 310 which is connected to the support frame, and moveably engages with the door in opening and closing of the food-treatment material chamber, and a door position adjuster which connects the support frame to the door support frame with a variable distance therebetween (e.g., one or more, for example, of 200a, 200b, 400, and 500) where varying of the distance between the support frame and the door support frame by the door position adjuster, adjusts the planar position of the door at the opening.

The door position adjuster connects the support frame to the door support frame at multiple connection locations (e.g., at 200a, 200b, 130a and 130b, for example), to respectively define variable distances at the multiple connection locations. The variable distances are independently controlled by the door position adjuster to adjust the planar position of the door at the opening.

By the above configuration, the cooking appliance 1 according to the spirit of the present disclosure includes the door pusher 310 provided to come in contact with the steam door 40 upon closing of the steam door 40 and the support frame 100 configured to support the door pusher 310. The steam door 40 may be movable together with the door pusher 310 and/or the support frame 100 which is coupled to the door pusher 310. The cooking appliance 1 further includes the adjustment member 400 provided to adjustably fasten the support frame 100 to the frame fastening portion 200, which disposes a position of the support frame 100 relative to the frame fastening portion 200 adjustable, so that the position of the steam door 40 relative to the main body 10 can be adjusted, and eventually, the external quality of the cooking appliance 1 can be improved.

According to the spirit of the present disclosure, by including a door pusher configured to come in contact with a steam door, and an adjustment member configured to adjust the position of a support frame which supports the door pusher, a cooking appliance according to the spirit of the present disclosure can improve the external quality of appearance of the cooking appliance.

According to the spirit of the present disclosure, by including the adjustment member, the cooking appliance can adjust a step difference on the exterior between the steam door and a main body.

Specific embodiments illustrated in the drawings have been described above. However, the present disclosure is not limited to the embodiments described above, and those of ordinary skill in the art to which the disclosure pertains may make various changes thereto without departing from the gist of the technical spirit of the disclosure defined in the claims below.

What is claimed is:

1. A cooking appliance comprising:
a main body defining a cooking chamber, and an accommodation chamber which is separated from the cooking chamber and is open to outside the main body at an opening of the main body;
a steam container accommodated inside the accommodation chamber and accessible from outside of the accommodation chamber, via the opening, wherein the steam container stores a material;
a steam supplier which connects the steam container and the cooking chamber to each other, wherein the steam supplier generates steam from the material in the steam container and supplies generated steam to the cooking chamber;
a door which is coupled to main body, wherein the door opens and closes the accommodation chamber at the opening;
a door support frame supporting the door and fixed to the main body;
a door pusher support frame which is inside of the accommodation chamber, connected to the door support frame and moveable relative to the door support frame;
a door pusher connected to the door pusher support frame and provided to come in contact with the door upon closing of the door; and
a position adjuster which connects the door support frame to the door pusher support frame and is configured to adjust a position of the door relative to the door support frame.

2. The cooking appliance of claim 1, further comprising an elastic member which is between the main body and the door pusher support frame and elastically supports the door pusher support frame relative to the main body.

3. The cooking appliance of claim 2, wherein the elastic member is between the door support frame and the door pusher support frame.

4. The cooking appliance of claim 2, wherein
the door support frame and the door pusher support frame face each other along a direction, and
the elastic member is elastically deformed in the direction along which the door support frame and the door pusher support frame face each other.

5. The cooking appliance of claim 2, wherein
the door support frame and the door pusher support frame face each other along a direction, and
the elastic member applies an elastic force in the direction along which the door support frame and the door pusher support frame face each other.

6. The cooking appliance of claim 1, wherein the door pusher support frame includes a first side facing the door support frame, a second side opposite to the first side, and a through-hole through which the position adjuster extends to pass from the first side to the second side.

7. The cooking appliance of claim 6, wherein:
the position adjuster includes:
a fastening head which is bound to the second side to restrict movement of the position adjuster to the first side via the through-hole, and
a fastening body which is extended from the fastening head, passes through the through-hole of the door pusher support frame, and extends into the door support frame to connect the door support frame to the door pusher support frame; and
the through-hole of the door pusher support frame is smaller than the fastening head and larger than the fastening body.

8. The cooking appliance of claim 7, wherein:
the door is rotatably coupled to the main body with respect to an axis of rotation, at the door support frame; and
the through-hole of the door pusher support frame has a major dimension which extends parallel to the axis of rotation.

9. The cooking appliance of claim 7, wherein the position adjuster includes an elastic coil which surrounds the fastening body and is between the first side of the door pusher support frame and the door support frame.

10. The cooking appliance of claim 1, wherein:
the position adjuster is provided in plural including a plurality of adjustment members;
the door support frame includes a plurality of frame fastening portions which correspond to the plurality of adjustment members; and
distances between the door pusher support frame, and the door support frame at each of the plurality of frame fastening portions, respectively, are independently adjusted by the plurality of adjustment members of the position adjuster.

11. The cooking appliance of claim 10, wherein:
the door is rotatably coupled to the main body, with respect to an axis of rotation, at the door support frame; and
the plurality of adjustment members of the position adjuster are arranged spaced apart from each other in a direction parallel to the axis of rotation.

12. The cooking appliance of claim 10, wherein the door pusher is disposed between the plurality of adjustment members of the position adjuster.

13. The cooking appliance of claim 1, wherein:
the main body defines the opening at a side of the cooking appliance;
at the side of the cooking appliance, the main body includes an outer frame; and
the outer frame includes:
a first frame portion which defines the opening through which the steam container is accessible from the outside of the accommodation chamber;
a second frame portion which is adjacent to the first frame portion along the side of the cooking appliance and protrudes further from the accommodation chamber than the first frame portion; and
a stepped portion formed by the first frame portion and the second frame portion.

14. The cooking appliance of claim 13, wherein the position adjuster adjusts a planar position of the door to compensate the stepped portion of the outer frame.

15. The cooking appliance of claim 14, wherein
the door support frame extends along the outside of the first frame portion, through the opening of the first frame portion, and into the accommodation chamber; and
adjustment of the planar position of the door includes tilting the position of the door by the position adjuster together with the door pusher support frame within the opening of the first frame portion, to compensate the stepped portion of the outer frame.

16. The cooking appliance of claim 13, wherein
the door support frame extends from outside the first frame portion, through the opening of the first frame portion, and into the accommodation chamber, and
the position adjuster connects the door support frame to the door pusher support frame, inside the accommodation chamber.

17. The cooking appliance of claim 1, wherein
the door pusher is moveably connected to the door pusher support frame; and
movement of the door pusher support frame toward the door presses the door pusher against the door to open the accommodation chamber.

18. A cooking appliance comprising:
a main body defining a cooking chamber, a food-treatment material chamber which is separated from the cooking chamber and open to outside the main body, at an opening of the main body, and an outer surface which has a stepped portion at the opening;
a food-treatment container accommodated in the food-treatment material chamber and accessible from outside of the food-treatment material chamber, via the opening, wherein the food-treatment container stores a food-treatment material;
a food-treatment material supplier which supplies the food-treatment material from the food-treatment material chamber to the cooking chamber;
a door which is coupled to main body, and opens and closes the food-treatment material chamber, at the opening; and
a door adjuster which is connected to the door, extends along the outer surface of the main body at the opening, and adjusts a planar position of the door at the opening to compensate the stepped portion of the outer surface of the main body.

19. The cooking appliance of claim 18, wherein the door adjuster includes:
a door support frame which extends along the outer surface of the main body, at the opening, and through the opening of the main body, to be disposed in the food-treatment material chamber, and maintains a fixed position relative to the outer surface, and supports the door;
a support frame moveable relative to the door support frame within the food-treatment material chamber;
a door pusher which is connected to the support frame, and moveably engages with the door in opening and closing of the food-treatment material chamber, and
a door position adjuster which connects the support frame to the door support frame with a variable distance therebetween,
wherein varying of the distance between the support frame and the door support frame by the door position adjuster, adjusts the planar position of the door at the opening.

20. The cooking appliance of claim 19, wherein
the door position adjuster connects the support frame to the door support frame at multiple connection locations, to respectively define variable distances at the multiple connection locations; and
the variable distances are independently controlled by the door position adjuster to adjust the planar position of the door at the opening.
